(19) United States
(12) Patent Application Publication
(10) Pub. No.: US 2019/0346888 A1
(43) Pub. Date: Nov. 14, 2019

(54) INFORMATION PROCESSING APPARATUS AND SYSTEM AND NON-TRANSITORY COMPUTER READABLE MEDIUM

(71) Applicant: FUJI XEROX CO., LTD., Tokyo (JP)

(72) Inventor: Kengo TOKUCHI, Kanagawa (JP)

(73) Assignee: FUJI XEROX CO., LTD., Tokyo (JP)

(21) Appl. No.: 16/400,069

(22) Filed: May 1, 2019

(30) Foreign Application Priority Data
May 11, 2018 (JP) 2018-092520

(51) Int. Cl. G06F 1/16

(52) U.S. Cl. CPC G06F 1/1652; G06F 1/163; G06F 1/1618

(57) ABSTRACT

An information processing apparatus includes a receiver and a switching unit. The receiver receives a user instruction to shift the entirety of an image. The display position of the image is not fixed. The switching unit causes currently displayed image to continue to be displayed while a distance by which the currently displayed image is shifted in a direction indicated in the user instruction does not exceed a threshold and causes the entirety of the currently displayed image to switch to another image when the distance is greater than or equal to the threshold.

### CROSS-REFERENCE TO RELATED APPLICATIONS

This application is based on and claims priority under 35 USC 119 from Japanese Patent Application No. 2018-092520 filed May 11, 2018.

### BACKGROUND

### (i) Technical Field

The present disclosure relates to an information processing apparatus and system, and a non-transitory computer readable medium.

### (ii) Related Art

An electronic signage system is an example of a technology for displaying information exceeding the range of a display area. With the electronic signage system, the entirety of information, such as a character string or a drawing, exceeding the display range can be displayed by scrolling through the display surface in one direction.

In office suites (or production software), the content in the display area is continuously switched as a result of a user moving a slider.

Japanese Unexamined Patent Application Publication No. 2008-33695 is an example of the related art.

### SUMMARY

Switching of information electronic signage is executed at predetermined intervals.

Aspects of non-limiting embodiments of the present disclosure relate to an information processing apparatus and system and a non-transitory computer readable medium that are capable of switching the entirety of a displayed image to another image in response to an instruction to shift the image provided from a user.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a receiver and a switching unit. The receiver receives a user instruction to shift the entirety of an image. The display position of the image is not fixed. The switching unit causes a currently displayed image to continue to be displayed while a distance by which the currently displayed image is shifted in a direction indicated in the user instruction does not exceed a threshold and causes the entirety of the currently displayed image to switch to another image when the distance is greater than or equal to the threshold.

### BRIEF DESCRIPTION OF THE DRAWINGS

Exemplary embodiments of the present disclosure will be described in detail based on the following figures, wherein:

FIGS. 1A and 1B illustrate an example of an information processing apparatus according to a first exemplary embodiment;

FIG. 2 is a block diagram illustrating an example of the hardware configuration of the information processing apparatus according to the first exemplary embodiment;

FIG. 3 is a block diagram illustrating an example of the functional configuration of the information processing apparatus of the first exemplary embodiment implemented as a result of a central processing unit (CPU) executing a program;

FIG. 4 is a diagram for explaining how to calculate a shifting distance in the first exemplary embodiment;

FIG. 5 is a table illustrating examples of standards used for determining how an image will be shifted or switched;

FIGS. 6A and 6B are views for explaining the unit of display;

FIGS. 7A and 7B illustrate an example of shifting of the display position of a currently displayed image and switching of the currently displayed image to the next image in response to a shifting operation performed by a user;

FIGS. 8A and 8B illustrate an example of shifting of the display position of a currently displayed image and switching of the currently displayed image to the previous image in response to a shifting operation performed by a user;

FIGS. 9A and 9B illustrate an example of shifting of the display position of a currently displayed image and switching of the currently played image to the next image in response to a shifting operation together with an auxiliary operation performed by a user;

FIGS. 10A and 10B illustrate an example of shifting of the display position of a currently displayed image and switching of the currently displayed image to the previous image in response to a shifting operation together with an auxiliary operation performed by a user;

FIGS. 11A and 11B illustrate another example of shifting of the display position of a currently displayed image and switching of the currently displayed image to the next image in response to a shifting operation together with an auxiliary operation performed by a user;

FIGS. 12A and 12B illustrate another example of shifting of the display position of a currently displayed image and switching of the currently displayed image to the previous image in response to a shifting operation together with an auxiliary operation performed by a user;

FIGS. 13A and 13B illustrate an example of an image switching operation performed by tapping;

FIGS. 14A and 14B illustrate an example of an image switching operation performed by double-tapping;

FIGS. 15A and 15B illustrate an example of shifting of the display position of a currently displayed image and switching of the currently displayed image to the next image in response to a shifting operation in the direction toward an end portion of the display surface;

FIGS. 16A and 16B illustrate an example of shifting of the display position of a currently displayed image and switching of the currently displayed image to the previous image in response to a shifting operation in the direction toward the other end portion of the display surface;

FIGS. 17A and 17B illustrate an example in which a displayed image is cyclically shifted when a user has moved a fingertip in a specific direction;

FIGS. 17C and 17D illustrate an example in which a displayed image is not cyclically shifted when a user has moved a fingertip in another direction;

FIGS. 18A and 18B illustrate another example in which a displayed image is cyclically shifted when a user has moved a fingertip in a specific direction;

FIGS. 18C and 18D illustrate another example in which a displayed image is not cyclically shifted when a user has moved a fingertip in another direction;

FIGS. 19A and 19B illustrate an information processing apparatus including a body formed in a cuboid shape and four display surfaces disposed continuously on the peripheral surface of the body according to a second exemplary embodiment;

FIG. 20 illustrates an information processing apparatus including a body formed in a spherical shape and a display surface disposed on the surface of the body according to a third exemplary embodiment;

FIGS. 21A through 21C illustrate an information processing apparatus including a body formed in a rectangular cuboid and a rectangular display surface according to a fourth exemplary embodiment;

FIG. 22 illustrates an example of a technique for informing a user that image switching will soon occur according to a fifth exemplary embodiment;

FIGS. 23A through 23C illustrate the schematic configuration of an information processing apparatus which forms an aerial image in the air according to a sixth exemplary embodiment;

FIGS. 24A and 24B are views for explaining how an aerial image forming device forms an aerial image;

FIG. 25 is a view for explaining how an aerial image forming device forms a three-dimensional image as an aerial image;

FIGS. 26A and 26B are views for explaining how an aerial image forming device forms an aerial image by using a micromirror array;

FIG. 27 is a view for explaining how an aerial image forming device forms an aerial image by using a beam splitter and a retroreflective sheet;

FIG. 28 is a view for explaining how an aerial image forming device forms a set of plasma emitting members as an aerial image;

FIGS. 29A and 29B illustrate a technique for setting a print area on a 360°-continuous display surface according to a seventh exemplary embodiment;

FIG. 30 illustrates examples of functions implemented as a result of a CPU executing a program;

FIGS. 31A and 31B illustrate an example of the execution of printing when one edge portion is set and the print direction is leftward (clockwise);

FIGS. 32A and 32B illustrate an example of the execution of printing when two edge portions are set and the print direction is rightward (counterclockwise);

FIGS. 33A and 33B illustrate an example in which the print direction is automatically determined according to the content of a displayed image;

FIGS. 34A and 34B illustrate an example of the execution of printing when display areas of a display surface are distinguishable from each other from the physical shape of the display surface; and

FIGS. 35A and 35B illustrate another example of the execution of printing when display areas of a display surface are distinguishable from each other from the physical shape of the display surface.

### DETAILED DESCRIPTION

Exemplary embodiments of the disclosure will be described below with reference to the accompanying drawings.

### First Exemplary Embodiment

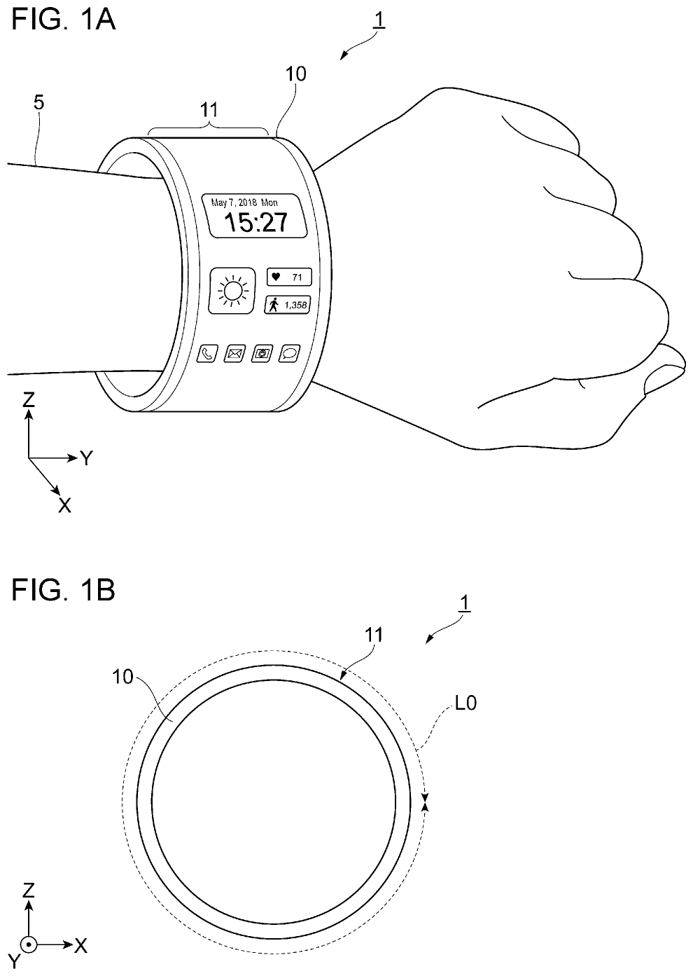

FIGS. 1A and 1B illustrate an example of an information processing apparatus 1 according to a first exemplary embodiment, 1A shows how the information processing apparatus 1 can be used. FIG. 1B is a side view of the information processing apparatus 1.

The information processing apparatus 1 shown in FIG. 1A is worn on an arm 5 of a user.

In the first exemplary embodiment, the information processing apparatus 1 includes a cylindrical body 10 and a display surface 11. The display surface 11 is disposed along the entirety of the outer peripheral surface of the body 10. That is, the display surface 11 is an example of a 360° display. In other words, the display surface 11 has a curved shape.

In FIG. 1B, the length of the circumference of the display surface 11 cut along a plane perpendicular to the rotational axis of the cylindrical body 10 is indicated by L0.

The display surface 11 is physically continuous by 360°. However, the display surface 11 may be constituted by a set of plural display devices, provided that it can be used almost in the same manner as the 360°-continuous display surface 11.

In the first exemplary embodiment, the maximum display area of the display surface 11 is the area defined by the entire circumference and the entire width. That is, the entirety of the area of the display surface 11 that a user can view is the maximum range of the area used for displaying information.

In the following description, the display area is the entirety of the display surface 11, unless otherwise stated.

In the first exemplary embodiment, the display surface 11 is constituted by a panel, such as an organic electroluminescence (EL) panel or a liquid crystal panel. On the display surface 11 shown in FIG. 1A, various items of information, such as those about the weather, time, heart rate, and daily steps, and functional buttons for email and telephone, for example, are disposed. Not only still images, but also video images may be displayed on the display surface 11.

Other information may be displayed on the display surface 11. For example, values output from various sensors integrated in the body 10 may be displayed, information received from an external source via a communication function may be displayed, and information read from a storage device, which is not shown, may also be displayed.

In the first exemplary embodiment, the body 10 is formed in a cylindrical shape. However, the body 10 may have a separated portion at a mid-position of the circumferential surface, so that the user can wear it on the arm 5 or remove it by opening the ends of the separated portion. A certain fixture (not shown), such as a buckle, may be attached to the ends of the separated portion. The body 10 may be a band-like member made of an elastic material.

In the first exemplary embodiment, the display surface 11 is attached to the body 10 so that it can be continuous by 360° when the body 10 is worn on the arm 5. Alternatively, the display surface 11 may have a gap in the circumferential direction so that it becomes discontinuous when the body 10 is worn on the arm 5. For example, the display surface 11 may be continuous by 350°, 300°, 180°, or 120° in the circumferential direction.

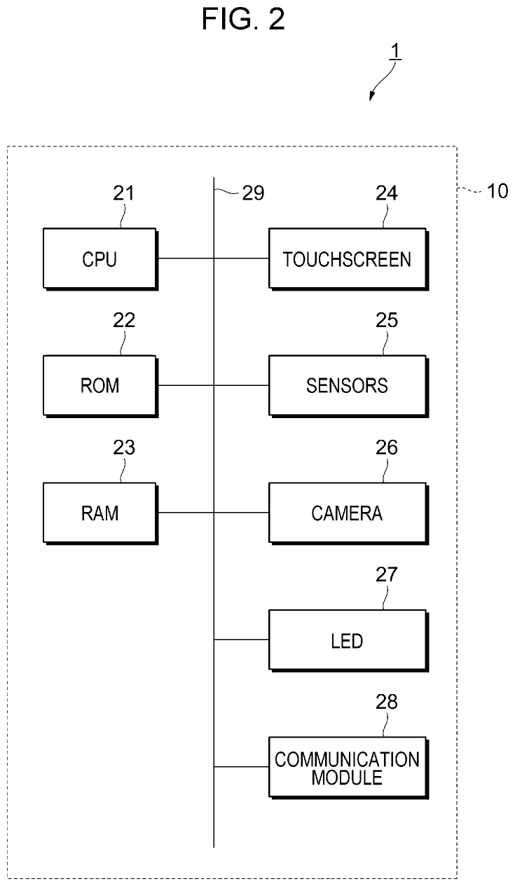

FIG. 2 is a block diagram illustrating an example of the hardware configuration of the information processing apparatus 1 according to the first exemplary embodiment.

The body 10 includes a central processing unit (CPU) 21, a read only memory (ROM) 22, and a random access memory (RAM) 23. The CPU 21 controls the entirety of the information processing apparatus 1 as a result of executing a program (including firmware). The ROM 22 stores programs, such as basic input output system (BIOS) and firmware. The RAM 23 is used as a work area for programs.

The CPU 21, the ROM 22, and the RAM 23 function as a computer and execute various information processing operations. The ROM 22 is constituted by a non-volatile semiconductor memory.

The body 10 also includes a touchscreen 24, sensors 25, a camera 26, a light-emitting diode (LED) 27, and a communication module 28. The touchscreen 24 forms the display surface 11 (see FIGS. 1A and 1B). The sensors 25 output a physical quantity of a subject as an electric signal. The camera 26 captures an image of a subject. The LED 27 serves as 4 light source. The communication module 28 is used for communicating with an external device. These elements are connected to each other via a bus 29.

On the touchscreen 24, an operation detection device and a display device are provided. The operation detection device detects the position of a subject, such as a user's fingertip, on the display surface 11. The display device is constituted by an organic EL panel or a liquid crystal panel and is used for displaying information.

The sensors 25 include an atmospheric temperature sensor, a body temperature sensor, a pulse rate sensor, an acceleration sensor, a gyro sensor, a magnetic sensor, a global positioning system (GPS) sensor, an ambient light sensor, a proximity sensor, and a fingerprint sensor, for example. Output from the acceleration sensor is used for measuring the number of steps a user has walked, for example. The sensors 25 may not necessarily include all of the above-described sensors, and may include only some of them.

The communication module 28 includes, for example, a wireless fidelity (WiFi) (registered trademark) module that sends and receives wireless signals compliant with the WiFi standard and a Bluetooth (registered trademark) module that sends and receives wireless signals compliant with the Bluetooth standard, which is one of the near field communication standards.

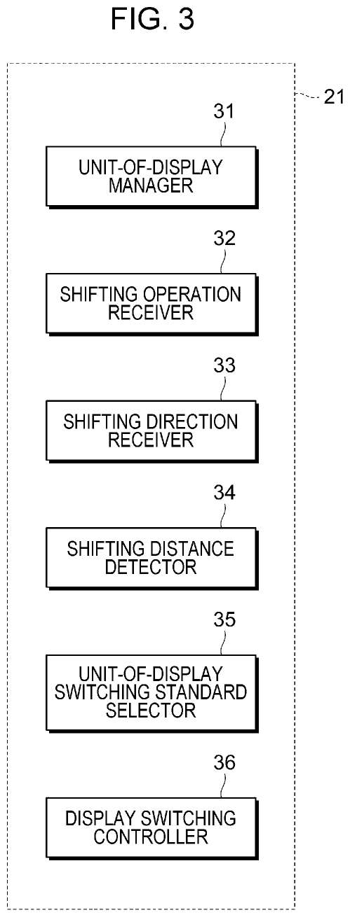

FIG. 3 is a block diagram illustrating an example of the functional configuration implemented as result of the CPU 21 executing a program.

The functional configuration shown in FIG. 3 is a configuration limited to the following image switching function. The image switching function is a function of shifting the entirety of an image displayed on the display surface 11 (see FIGS. 1A and 1B) in response to a user instruction while maintaining the identity of the image.

Maintaining the identity of an image refers to that the content of a displayed image remains the same even if the position of the displayed image within the display surface 11 is changed.

Images displayed on the display surface 11 at fixed positions are excluded from subjects of this function. In other words, all images that are movably displayed on the display surface 11 are subjects to be shifted within the display surface 11 by using this function. Icons and times located along the edge of the display of a smartphone or a computer are examples of the images displayed on the display surface 11 at fixed positions. Changing the display positions of these icons and times does not maintain their identities and is thus different from shifting of an image by using this function in the first exemplary embodiment.

Maintaining the identity of an image refers to a state in which, if an image displayed on the display surface 11 is a still image, no excess or no shortage occurs to elements forming the image on the display surface 11. An excess of the elements forming the image means that a new element is added as a result of shifting the image. A shortage of the elements forming the image means that an element included in the image is eliminated as a result of shifting the image.

Maintaining the identity of an image refers to a state in which, if part of an image displayed on the display surface 11 is a video image, no excess or no shortage occurs to elements forming the image on the display surface 11, except for the video image.

If the entirety of an image displayed on the display surface 11 is a video image, maintaining the identity of an image refers to a state in which the content of the displayed image remains the same even if the display position of the image is changed.

Maintaining the identity of an image is also applied to a case involving changing of a layout, for example, in which an image is enlarged in a specific area of the display surface 11.

In other words, shifting of an image while maintaining its identity refers to that the display position of an image displayed on the display surface 11 is changed in such a manner that the entirety of the image is cyclically shifted or rotated in a shifting direction. Rotation is one mode of cyclic shifting.

Cyclic shifting refers to a state in which, in response to an instruction to shift an image toward an end portion of the display surface 11 (toward the opening in FIGS. 1A and 1B), the image positioned at one end portion disappears outside the display surface 11 and appears again from the other end portion of the display surface 11.

Accordingly, for example, displaying a character string exceeding the display range by scrolling through the display surface, such as in electronic signage, is not a case in which an image is shifted while maintaining its identity.

In the case of document creation software of office suites (or production software), new information appears on the screen from a side on which a slider is moved, and information displayed on the opposite side disappears from the screen. Accordingly, this is not a case in which an image is shifted while maintaining its identity.

The reason why the cyclic displaying function is provided in the first exemplary embodiment is that part of the cylindrical display surface 11 is not physically seen from a user. The user is able to see the entirety of an image displayed on the display surface 11 by rotating the position of the image in the circumferential direction.

The user may alternatively rotate the body 10 (see FIGS. 1A and 1B) around the arm 5, but this is not always feasible As in the first exemplary embodiment, the function of rotating only the display position is useful in terms of viewing the entirety of an image.

The CPU 21 shown in FIG. 3 serves as a unit-of-display manager 31, a shifting operation receiver 32, a shifting direction receiver 33, a shifting distance detector 34, a unit-of-display switching standard selector 35, and a display switching controller 36. The unit-of-display manager 31 causes an image to continue to be displayed while the distance by which the image displayed on the display surface 11 is shifted (hereinafter called the shifting distance) is smaller than a predetermined threshold. That is, the unit-of-display manager 31 manages the unit of display. The shifting operation receiver 32 receives a shifting operation from a user. The shifting direction receiver 33 receives the direction of a shifting operation from a user. The shifting distance detector 34 detects the shifting distance according to the direction. The unit-of-display switching standard selector 35 selects a standard indicating how an image, which is a unit of display, will be shifted or switched. The display switching controller 36 controls the switching of an image to be displayed, based on the selection result supplied from the unit-of-display switching standard selector 35.

In the first exemplary embodiment, the unit of display corresponds to an image displayed on the maximum display area of the display surface 11, and is also a unit by which an image is switched, as stated above.

If part of the maximum display area of the display surface 11 is secured for specific images, such as operation buttons, the unit of display is determined as an image to be displayed in the area except for an area secured for such specific images.

The unit-of-display manager 31 manages, for example, the relationship between an image (unit of display) which is currently displayed on the display surface 11 and an image (unit of display) which will be displayed after a switching operation. For example, the unit-of-display manager 31 manages the relationship concerning the display order of images, such as an image to be displayed next and an image to be displayed after next.

The unit-of-display manager 31 may manage the above-described relationship according to the shifting direction. For example, the unit-of-display manager 31 may vary the unit of display according to the shifting direction. In the example in FIGS. 1A and 1B, the unit-of-display manager 31 may vary a group of images to be displayed (unit of display) according to whether the shifting operation is performed in the direction toward the end portions of the cylindrical body 10 (toward the opening) or in the direction substantially perpendicular to the direction toward the end portions (360°-rotating direction).

The shifting operation receiver 32 receives, among operations performed by a user on the touchscreen 24 (see FIG. 2), an operation that can be regarded as a shifting instruction.

In the first exemplary embodiment, tapping on the display surface 11 in a specific direction with a fingertip, flicking the display surface 11 in a specific direction with a fingertip, and sliding a fingertip over the display surface 11 while holding it in contact with the display surface 11 are all regarded as shifting instructions.

The shifting direction receiver 33 receives, as the shifting direction, the direction of an operation received as a shifting instruction. In the example in FIGS. 1A and 1B, the shifting direction receiver 33 receives the shifting direction by detecting whether the direction of the shifting operation performed on the information processing apparatus 1 worn on the arm 5 is clockwise along the display surface 11, counterclockwise along the display surface 11, rightward toward the opening, or leftward toward the opening.

The shifting direction may include an oblique direction. The oblique direction may be divided into two components, that is, one component in the direction substantially perpendicular to the end portions of the display surface 11 and the other component in the direction toward the end portions.

The shifting distance detector 34 detects the shifting distance according to the direction, based on a reference position, that is, the position of an image displayed on the display surface 11 as the unit of display.

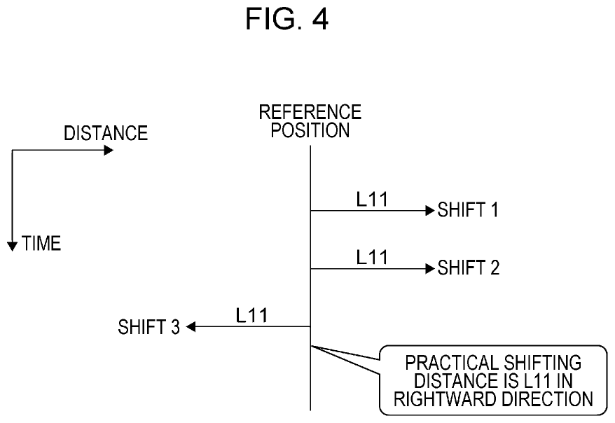

FIG. 4 is a diagram for explaining how to calculate the shifting distance in the first exemplary embodiment. In the first exemplary embodiment, the shifting direction and the shifting distance are calculated by considering the overall shifting operations performed chronologically, assuming that the shifting distance in one direction with respect to the reference position is positive (plus) and the shifting distance in the other direction with respect to the reference position is negative (minus).

In the example in FIG. 4, an operation for shifting in the rightward direction by distance L11 is performed twice, and an operation for shifting in the leftward direction by distance L11 is also performed once. The practical shifting distance is thus detected as the distance L11 in the rightward direction.

In the example in FIG. 4, the calculated shifting distance does not reflect how the shifting operation has been performed. For example, if the shifting operation is performed by tapping or flicking on the display surface 11 with a fingertip, the shifting distance may be changed according to the tapping or flicking speed.

If a user slides a fingertip over the display surface 11, the sliding distance may be determined as the shifting distance.

Referring back to a description with reference to FIG. 3, the unit-of-display switching standard selector 35 selects a switching standard representing how an image (unit of display) will be shifted or switched in accordance with a combination of the shifting distance and the shifting direction and according to whether an auxiliary operation has been performed, and supplies a selection result to the display switching controller 36. The auxiliary operation will be discussed later.

The display switching controller 36 performs control so that an image will be switched based on the selection result. In this case, the control operation executed by the display switching controller 36 includes, not only switching of an image as the unit of display, but also shifting of the position of the image displayed as the unit of display within the display surface 11.

The display switching controller 36 is an example of a switching unit that switches the entirety of an image displayed on the display surface 11 to another image.

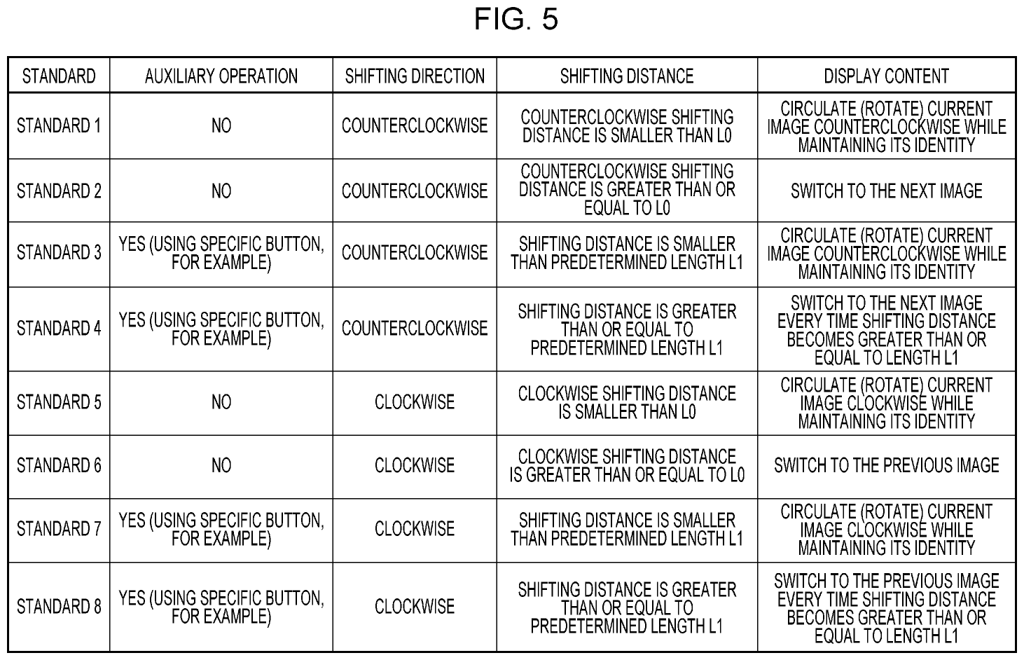

FIG. 5 is a table illustrating examples of the standards used for determining how an image will be shifted or switched.

In FIG. 5, eight standards are shown by way of examples. These standards are determined based on a combination of the shifting distance and the shifting direction and whether an auxiliary operation has been performed. In this case, the auxiliary operation is performed to provide an instruction to switch an image immediately.

For example, standard 1 is a case in which the auxiliary operation is not performed and the shifting distance in a predetermined direction (counterclockwise, for example) is smaller than a length L0, which is equal to the length of the circumference of the display surface 11. If the shifting distance satisfies standard 1, the display switching controller 36 performs control so that an image currently displayed on the display surface 11 will be circulated (rotated) counterclockwise while maintaining the identity of the image.

The auxiliary operation is different from an operation for providing an instruction to shift an image. The auxiliary operation may be performed by using one of buttons (not shown). The buttons include hardware keys provided on the body 10 (see FIGS. 1A and 1B) or software keys disposed on part of the display surface 11 separately from the display area for images. The auxiliary operation may be performed without using a button if it is distinguishable from an operation for providing a shifting instruction. Specific examples of the auxiliary operation will be discussed later.

With the auxiliary operation, the image displayed on the display surface 11 is immediately switched even if the shifting distance is smaller than the length L0.

Standard 2 is a case in which the auxiliary operation is not performed and the shifting distance in a predetermined direction (counterclockwise, for example) is greater than or equal to the length L0. If the shifting distance satisfies standard 2, the display switching controller 36 performs control so that an image currently displayed on the display surface 11 will be switched to the next image.

Standard 3 is a case in which the auxiliary operation is performed and the shifting distance in a predetermined direction (counterclockwise, for example) is smaller than a length L1 (<L0).

The length L1 is a length long enough to be able to check the direction of a shifting operation performed by a user. The length L1 may even be a length corresponding to a central angle of 1°.

Any length may be set as the length L1. A shorter length requires a shorter time for performing an operation for providing an instruction to switch to another image. However, an excessively short length increases the possibility of failing to detect the shifting distance correctly. It is desirable that the length L1 can be set or changed by an individual user.

If the shifting distance satisfies standard 3, the display switching controller 36 performs control so that an image currently displayed on the display surface 11 will be circulated (rotated) counterclockwise while maintaining the identity of the image.

Standard 4 is a case in which the auxiliary operation is performed and the shifting distance in a predetermined direction (counterclockwise, for example) is greater than or equal to the length L1 (<L0). In this case, every time the shifting distance is found to be greater than or equal to the length L1, the display switching controller 36 performs control so that an image currently displayed on the display surface 11 will be switched to the next image. This enables the user to reach the subject image that the user wishes to see in a short period of time.

Instead of using a combination of the shifting distance and the shifting direction and according to whether the auxiliary operation has been performed, a small screen (window) showing a list of popup images may be displayed so that the user can directly select a subject image from the list. The user may alternatively indicate by how many images will be skipped to display the subject image by using a numeric value.

Standard 5 is a case in which the auxiliary operation is not performed and the shifting distance in a predetermined direction (clockwise, for example) is smaller than the length L0. If the shifting distance satisfies standard 5, the display switching controller 36 performs control so that an image currently displayed on the display surface 11 will be circulated (rotated) clockwise while maintaining the identity of the image.

Standard 6 is a case in which the auxiliary operation is not performed and the shifting distance in a predetermined direction (clockwise, for example) is greater than or equal to the length L0. If the shifting distance satisfies standard 6, the display switching controller 36 performs control so that an image currently displayed on the display surface 11 will be switched to the previous image.

Standard 7 is a case in which the auxiliary operation is performed and the shifting distance in a predetermined direction (clockwise, for example) is smaller than the length L1 (<L0). If the shifting distance satisfies standard 7, the display switching controller 36 performs control so that an image currently displayed on the display surface 11 will be circulated (rotated) clockwise while maintaining the identity the image.

Standard 8 is a case in which the auxiliary operation is performed and the shifting distance in a predetermined direction (clockwise, for example) is greater than or equal to the length L1 (<L0). In this case, every time the shifting distance is found to be greater than or equal to the length L1, the display switching controller 36 performs control so that an image currently displayed on the display surface 11 will be switched to the previous image.

### (Display Examples)

Shifting and switching of images using the above-described function will be described below.

### (Unit of Display)

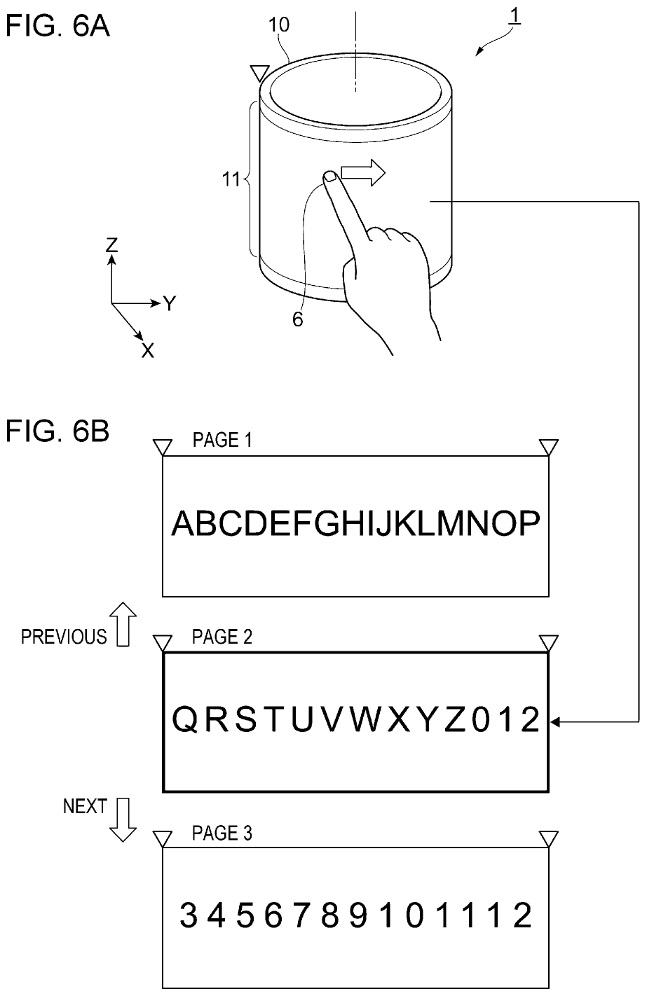

FIGS. 6A and 6B are views for explaining the unit of display. FIG. 5A shows a user operation performed on the information processing apparatus 1. FIG. 6B shows examples of images, each of which forms the unit of display, at different times.

In FIG. 6A, the user moves a fingertip 6 in the rightward direction (counterclockwise) along the circumference of the display surface 11. The shifting direction of the fingertip 6 is indicated by the arrow in FIG. 6A.

The shifting direction in FIG. 6A is the circumferential direction. An image as the unit of display on the display surface 11 is thus shifted in the rightward direction (counterclockwise) by the distance by which the user has moved the fingertip 6.

In FIG. 6B, three images are shown as the unit of display by way of example. In FIGS. 6A and 6B, the unit of display is managed by page.

For the convenience of representation, the image displayed along the circumference of the display surface 11 in FIG. 6A is displayed in a plane in FIG. 6B by cutting the display surface 11 at the reference position indicated by the inverted triangle. The same inverted triangle is indicated at both edges of each of the images in FIG. 6B.

Page 1 is constituted by a character string “ABCDEFGHIJKLMNOP” disposed along the circumferential direction.

Page 2 is constituted by a character string “QRSTUVWXYZ012” disposed along the circumferential direction.

Page 3 is constituted by a character string “3456789101112” disposed along the circumferential direction.

The current unit of display is page 2. The previous page is page 1, and the next page is page 3.

### (First Display Example)

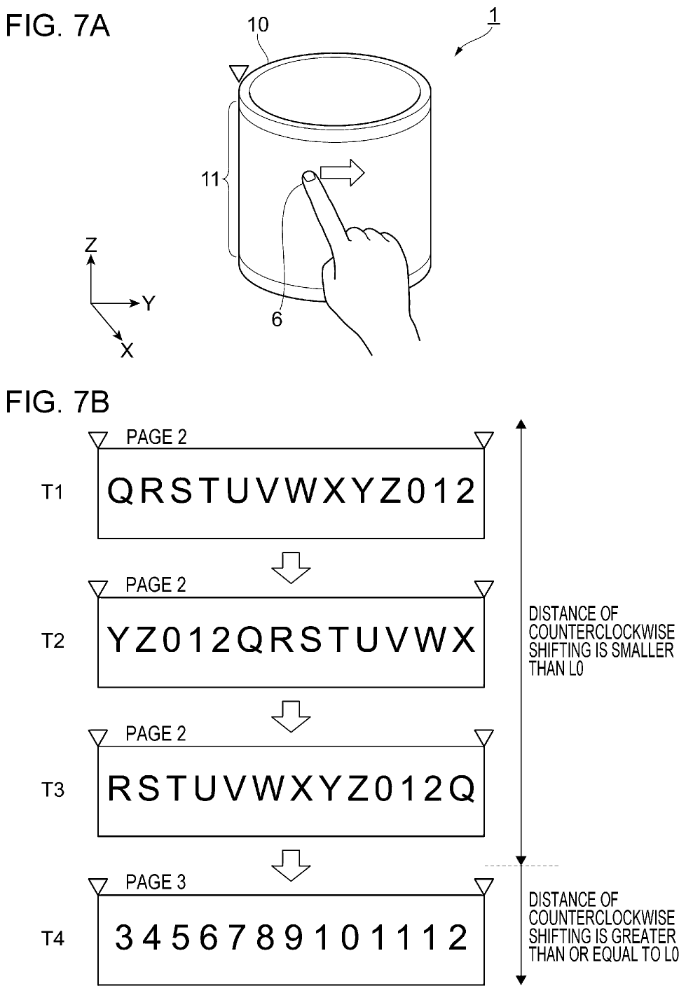

FIGS. 7A and 7B illustrate an example of shifting of the display position of a currently displayed image and switching of the currently displayed image to the next image in response to a shifting operation performed by a user. FIG. 7A shows a user operation performed on the information processing apparatus 1. FIG. 7B shows the transition of displayed images in response to a shifting operation.

In FIGS. 7A and 7B, the reference position is also indicated by the inverted triangle.

At time T1, page 2 is displayed as the unit of display. At time T1, a user has not yet provided a shifting instruction. In this case, the character string “QRSTUVWXYZ012” displayed in this order in the rightward direction (counterclockwise) from the reference position on the left side.

At time T2, the user has moved the fingertip 6 in the rightward direction (counterclockwise), and the arrangement of the character string displayed on the display surface 11 is indicated. At time T2, the position of the image is shifted in the rightward direction by five characters with respect to that at time T1. The character string “YZ012QRSTUVWX” is displayed on the display surface 11 in this order in the rightward direction from the reference position on the left side.

At time T3, the user has moved the fingertip 6 further in the rightward direction (counterclockwise), and the arrangement of the character string displayed on the display surface 11 is indicated. At time T3, the position of the image is shifted in the rightward direction by seven characters with respect to that at time T2. The character string “RSTUVWXYZ012Q” is displayed on the display surface 11 in this order in the rightward direction from the reference position on the left side.

That is, the character “Q” located at the head of the character string in the rightward direction (counterclockwise) as viewed from the reference position on the left side at time T1 is located at the tail of the character string at time T3.

In this state, if the user moves the fingertip 6 in the rightward direction (counterclockwise), the distance by which page 2 is shifted in the rightward direction becomes greater than or equal to the length L0, which is the length of the circumference of the display surface 11.

At time T4, the arrangement of the character string after the image displayed on the display surface 11 has changed from page 2 to page 3 is indicated.

In this manner, while the distance by which the image is shifted in the rightward direction (counterclockwise) in accordance with a user operation is smaller than the length L0, page 2, which forms the unit of display, is merely shifted along the display surface 11 in the shifting direction. However, when the display position of page 2 is rotated through one revolution, page 2 is switched to the next image, that is, page 3.

In the example in FIGS. 7A and 7B, the display surface 11 has a ring-like shape, and the length L0 of the circumference of the display surface 11 is used as the threshold for determining whether image switching will be performed. The length L0 is equal to the distance by one revolution around the display surface 11.

However, the length used as the threshold may be half of L0 (that is, L0/2) or one third of L0 (that is, L0/3).

### (Second Display Example)

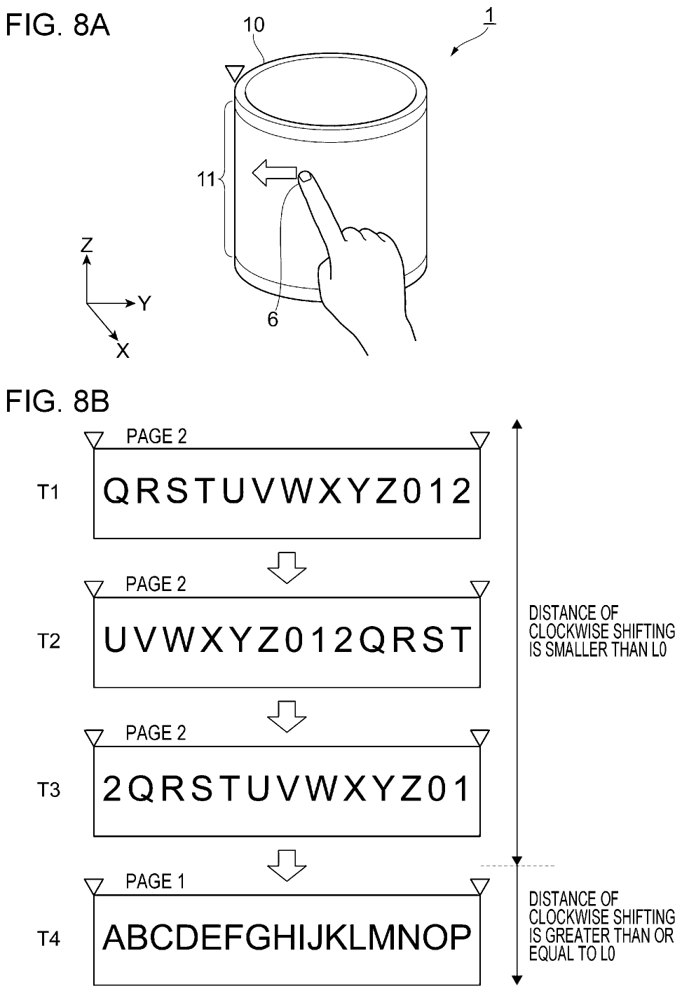

FIGS. 8A and 8B illustrate an example of shifting of the display position of a currently displayed image and switching of the currently displayed image to the previous image in response to a shifting operation performed by a user. FIG. 8A shows a user operation performed on the information processing apparatus 1. FIG. 8B shows the transition of displayed images in response to a shifting operation.

In FIGS. 8A and 8B, as well as in FIGS. 7A and 7B, the reference position is indicated by the inverted triangle.

The image displayed at time T1 is the same image in the first display example (see FIG. 7B). That is, page 2, which forms the unit of display, is displayed on the display surface 11. The character string “QRSTUVWXYZ012” is displayed in this order in the rightward direction (counterclockwise) from the reference position on the left side.

At time T2, the user has moved the fingertip 6 in the leftward direction (clockwise), and the arrangement of the character string displayed on the display surface 11 is indicated. At time T2, the position of the image is shifted in the leftward direction by four characters with respect to that at time T1. The character string “UVWXYZ012QRST” is displayed on the display surface 11 in this order in the rightward direction from the reference position on the left side.

At time T3, the user has moved the fingertip 6 further in the leftward direction (clockwise), and the arrangement of the character string displayed on the display surface 11 is indicated. At time T3, the position of the image is shifted in the leftward direction by eight characters with respect to that at time T2. The character string “2QRSTUVWXYZ01” is displayed on the display surface 11 in this order in the rightward direction from the reference position on the left side.

That is, the character “Q” located at the head of the character string in the rightward direction (counterclockwise) as viewed from the reference position on the left side at time T1 is located at the second character from the head of the character string at time T3.

In this state, if the user moves the fingertip 6 in the leftward direction (clockwise), the distance by which page 2 is shifted in the leftward direction becomes greater than or equal to the length L0, which is the length of the circumference of the display surface 11.

At time T4, the arrangement of the character string after the image displayed on the display surface 11 has changed from page 2 to page 1 is indicated.

In this manner, while the distance by which the image is shifted in the leftward direction (clockwise) in accordance with a user operation is smaller than the length L0, page 2, which forms the unit of display, is merely shifted along the display surface 11 in the shifting direction. However, when the display position of page 2 is rotated through one revolution, page 2 is switched to the previous image, that is, page 1.

In the example in FIGS. 8A and 8B, as well as in FIGS. 7A and 7B, the length L0 of the circumference of the display surface 11 is used as the threshold for determining whether image switching will be performed. However, the length used as the threshold may be half of L0 (that is, L0/2) or one third of L0 (that is, L0/3).

The length used as the threshold may be changed according to the shifting direction. For example, a currently displayed image is switched to the next image when the shifting distance in the rightward direction (counterclockwise) is greater than or equal to L0, while a currently displayed image is switched to the previous image when the shifting distance in the leftward direction (clockwise) is greater than or equal to L0/2.

### (Third Display Example)

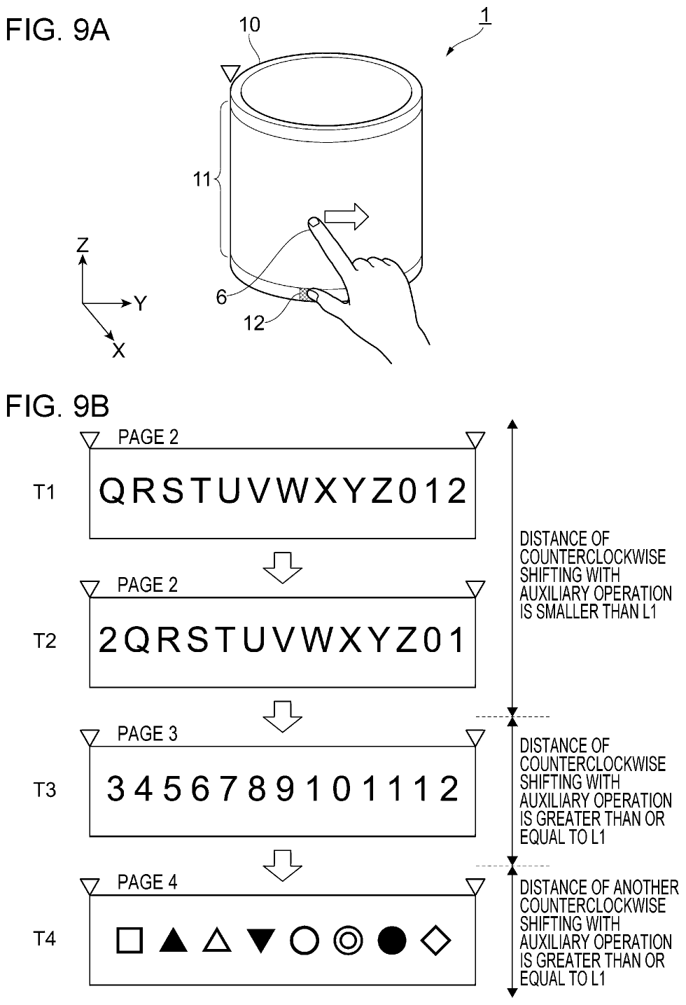

FIGS. 9A and 9B illustrate an example of shifting of the display position of a currently displayed image and switching of the currently displayed image to the next image in response to a shifting operation together with an auxiliary operation performed by a user. FIG. 9A shows a user operation performed on the information processing apparatus 1. FIG. 9B shows the transition of displayed images in response to a shifting operation.

In FIGS. 9A and 9B, the reference position is also indicated by the inverted triangle.

In FIGS. 9A and 9B, the user moves the fingertip 6 in the rightward direction (counterclockwise) while pressing a physical key 12 with the thumb. The physical key 12 is disposed on part of the body 10.

In response to a shifting operation together with the auxiliary operation, the shifting distance used as the threshold for determining whether image switching will be performed is changed to the length L1 (<L0).

In FIG. 9B, at time T1, page 2 is displayed as the unit of display.

At time T2, the user has moved the fingertip 6 in the rightward direction (counterclockwise), and the arrangement of the character string displayed on the display surface 11 is indicated. At time T2, the position of the image is shifted in the rightward direction by one character with respect to that at time T1. The character string “2QRSTUVWXYZ01” is displayed on the display surface 11 in this order in the rightward direction from the reference position on the left side.

The shifting distance by one character is smaller than the length L1.

At time T3, the user has moved the fingertip 6 further in the rightward direction (counterclockwise), and the arrangement of the character string displayed on the display surface 11 is indicated. At time T3, the shifting distance in the rightward direction (counterclockwise) is greater than or equal to the length L1, which is the threshold for determining whether image switching will be performed.

As a result, the image displayed on the display surface 11 is switched from page 2 to page 3.

In this state, at time T4, the user has moved the fingertip 6 further in the rightward direction (counterclockwise) by a distance greater than or equal to the length L1. The image displayed on the display surface 11 is thus switched from page 3 to page 4. Page 4 is an image constituted by symbols.

In this manner, while the distance by which the image is shifted in the rightward direction (counterclockwise) in accordance with a user operation is smaller than the length L1, page 2, which forms the unit of display, is merely shifted along the display surface 11 in the shifting direction. However, if the shifting distance is greater than or equal to the length L1, page 2 is switched to the next image, that is, page 3. Thereafter, if the user has moved the fingertip 6 in the rightward direction (counterclockwise) again by a distance greater than or equal to the length L1, page 3 is switched to the next page, that is, page 4.

By combining the auxiliary operation with a shifting operation, a user is able to switch an image by a shorter shifting distance.

### (Fourth Display Example)

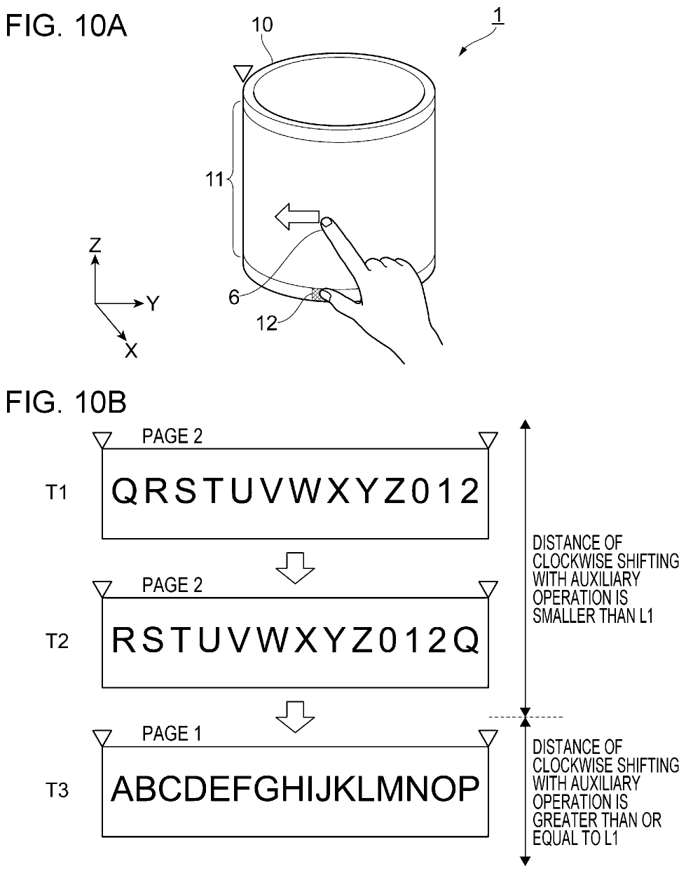

FIGS. 10A and 10B illustrate an example of shifting of the display position of a currently displayed image and switching of the currently displayed image to the previous image in response to a shifting operation together with an auxiliary operation performed by a user. FIG. 10A shows a user operation performed on the information processing apparatus 1. FIG. 10B shows the transition of displayed images in response to a shifting operation.

In FIGS. 10A and 10B, the reference position is also indicated by the inverted triangle.

As in the third display example, the user presses the physical key 12 with the thumb. In the fourth display example, however, the user moves the fingertip 6 in the leftward direction (clockwise).

In FIG. 10B, at time T1, page 2 is displayed as the unit of display.

At time T2, the user has moved the fingertip 6 in the leftward direction (clockwise), and the arrangement of the character string displayed on the display surface 11 is indicated. At time T2, the position of the image is shifted in the leftward e by one character with respect to that at time T1. The character string “RSTUVWXYZ012Q” is displayed on the display surface 11 in this order in the rightward direction (counterclockwise) from the reference position on the left side.

The shifting distance by one character is smaller than the length L1.

At time T3, the user has moved the fingertip 6 further in the leftward direction (clockwise), and the arrangement of the character string displayed on the display surface 11 is indicated. At time T3, the shifting distance in the leftward direction (clockwise) is greater than or equal to the length L1, which is the threshold for determining whether image switching will be performed.

As a result, the image displayed on the display surface 11 is switched from page 2 to page 1.

In this manner, while the distance by which the image is shifted in the leftward direction (clockwise) in accordance with a user operation is smaller than the length L1, page 2, which forms the unit of display, is merely shifted along the display surface 11 in the shifting direction. However, if the shifting distance is greater than or equal to the length L1, page 2 is switched to the previous page, that is, page 1.

By combining the auxiliary operation with a shifting operation, a user is able to switch an image by a shorter shifting distance.

### (Fifth Display Example)

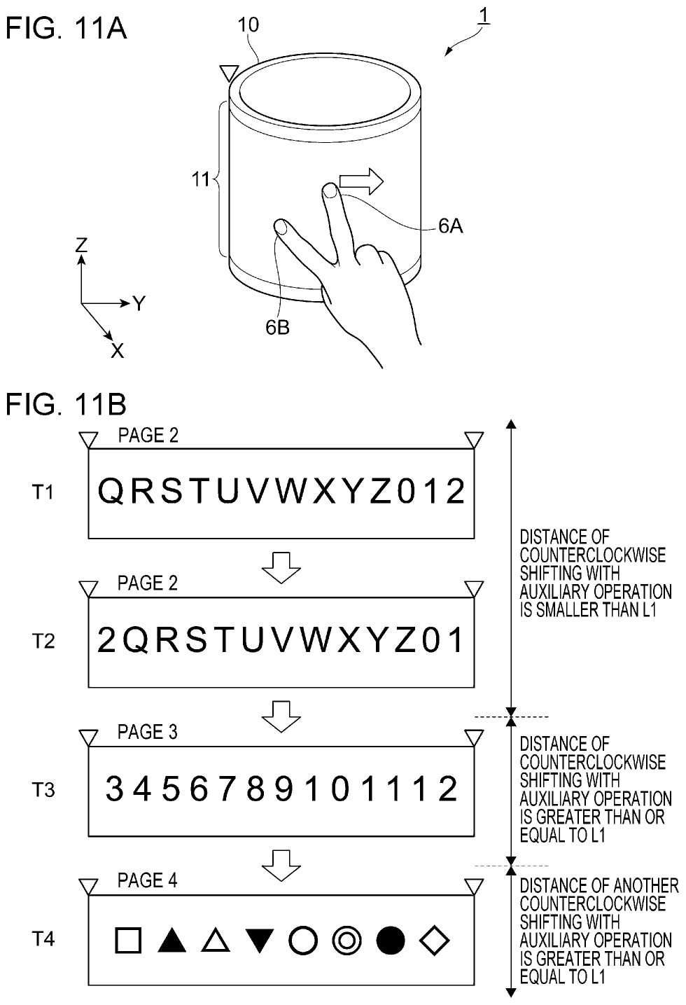

FIGS. 11A and 11B illustrate another example of shifting of the display position of a currently displayed image and switching of the currently displayed image to the next image in response to a shifting operation together with an auxiliary operation performed by a user. FIG. 11A shows a user operation performed on the information processing apparatus 1. FIG. 11B shows the transition of displayed images in response to a shifting operation.

In the fifth display example, a shifting instruction using two fingertips 6A and 6B is received as a shifting operation with an auxiliary operation. In FIG. 11A, the user moves the fingertip 6A of the middle finger and the fingertip 6B of the index finger in the rightward direction (counterclockwise). However, the user may use other fingers for providing a shifting instruction.

In FIGS. 11A and 11B, the reference position is also indicated by the inverted triangle.

When the user has moved the two fingertips 6A and 6B along the display surface 11 while holding them in contact with the display surface 11, the shifting operation receiver 32 (see FIG. 3) receives this operation as a shifting operation with an auxiliary operation.

Upon receiving this operation, the length L1 is set as the threshold for determining whether image switching will be performed.

Thereafter, the image will be switched in the same manner as in the third display example (see FIG. 9B).

### (Sixth Display Example)

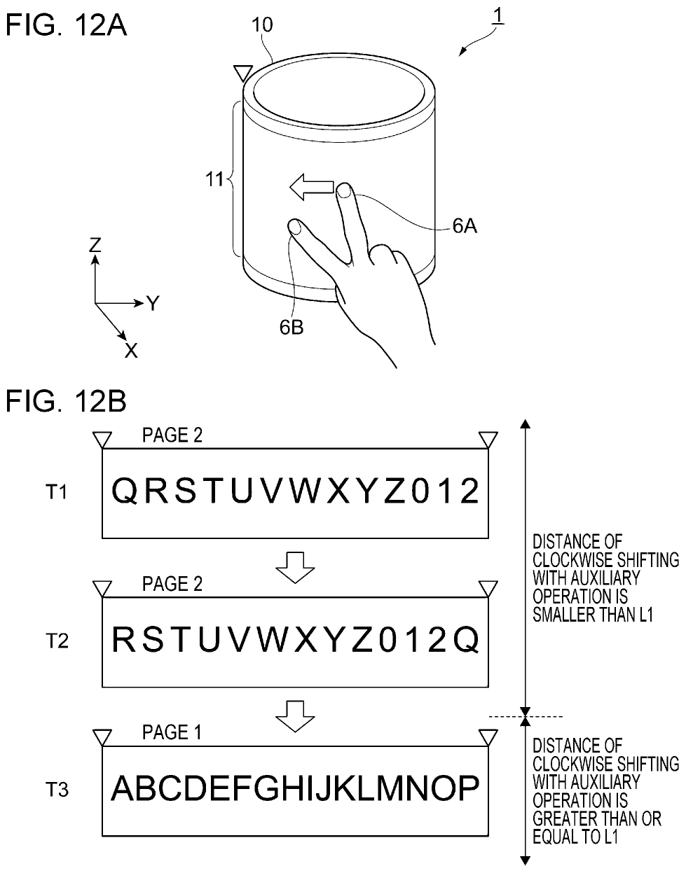

FIGS. 12A and 12B illustrate another example of shifting of the display position of a currently displayed image and switching of the currently displayed image to the previous image in response to a shifting operation together with an auxiliary operation performed by a user. FIG. 12A shows a user operation performed on the information processing apparatus 1. FIG. 12B shows the transition of displayed images in response to a shifting operation.

In the sixth display example, as well as in the fifth display example, a shifting instruction using the two fingertips 6A and 6B is received as a shifting operation with an auxiliary operation. In FIG. 12A, the user moves the fingertip 6A of the middle finger and the fingertip 6B of the index finger in the leftward direction (clockwise), which is the opposite direction of that in the fifth display example.

In FIGS. 12A and 12B, the reference position is also indicated by the inverted triangle.

When the user has moved the two fingertips 6A and 6B along the display surface 11 while holding them in contact with the display surface 11, the shifting operation receiver 32 (see FIG. 3) receives this operation as a shifting operation with an auxiliary operation.

Upon receiving this operation, the length L1 is set as the threshold for determining whether image switching will be performed.

Thereafter, the image will be switched in the same manner as in the fourth display example (see FIG. 10B).

### (Seventh Display Example)

In the seventh display example, an instruction to switch a displayed image is simplified.

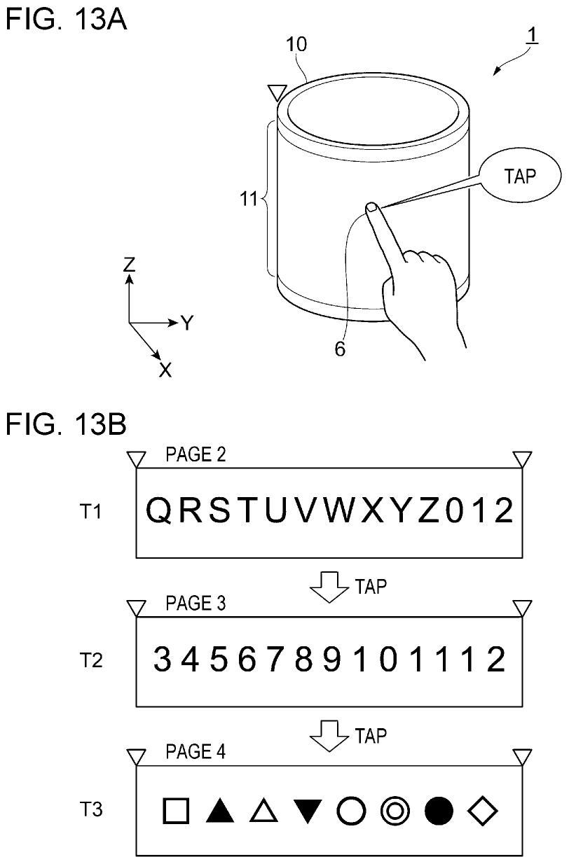

FIGS. 13A and 13B illustrate an example of an image switching operation performed by tapping. In this operation, when a user taps on the display surface 11 once, a displayed image is switched to the next image. FIG. 13A shows a user operation performed on the information processing apparatus 1. FIG. 13B shows the transition of displayed images in response to a switching operation.

In FIGS. 13A and 13B, page 2 is used as the initial screen before an operation is received. In the seventh display example, every time the user taps on the display surface 11, the initial screen is switched to page 3, page 4, and so on.

When tapping on the display surface 11 is detected, a screen for receiving a user operation may be displayed. By using this screen, the user may indicate by how many pages the current page will move forward or to which page the current page will be switched.

### (Eighth Display Example)

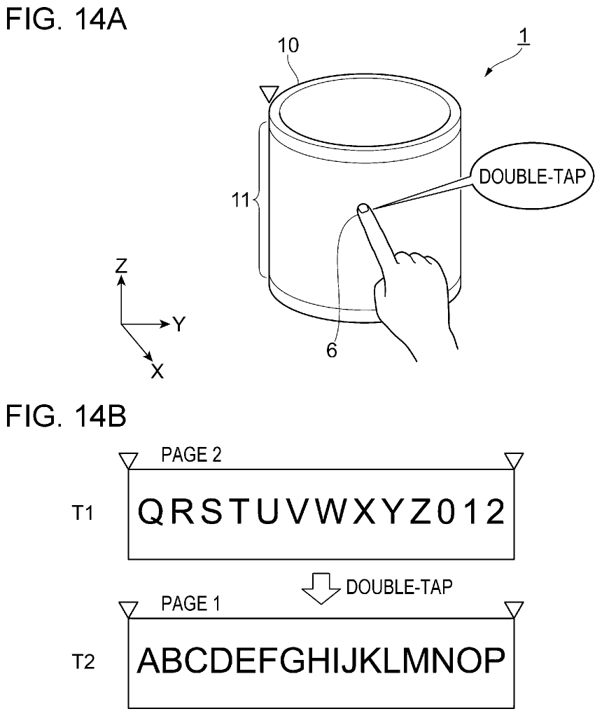

FIGS. 14A and 14B illustrate an example of an image switching operation performed by tapping. In this case, when a user taps on the display surface 11 twice (double-tapping), a displayed image is switched to the previous image. FIG. 14A shows a user operation performed on the information processing apparatus 1. FIG. 14B shows the transition of displayed images in response to a switching operation.

In FIGS. 14A and 14B, page 2 is used as the initial screen before an operation is received. In the eighth display example, when the user double-taps on the display surface 11, the initial screen is switched to page 1.

When double-tapping on the display surface 11 is detected, a screen for receiving a user operation may be displayed. By using this screen, the user may indicate by how many pages the current page will move backward or to which page the current page will be switched.

### (Ninth Display Example)

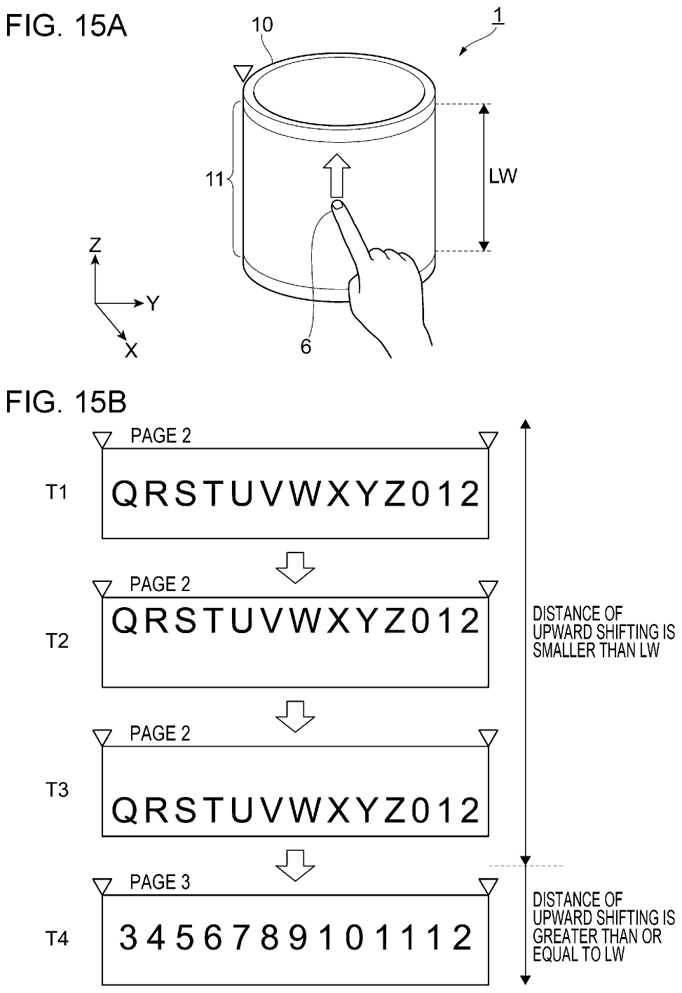

FIGS. 15A and 15B illustrate an example of shifting of the display position of a currently displayed image and switching of the currently displayed image to the next image in response to a shifting operation in the direction toward an end portion of the display surface 11. FIG. 15A shows a user operation performed on the information processing apparatus 1. FIG. 15B shows the transition of displayed images in response to a shifting operation.

In the example in FIGS. 15A and 15B, when the user has moved the fingertip 6 upward, the information processing apparatus 1 receives this operation as an instruction to switch to the next image. In the information processing apparatus 1 having a cylindrical body 10 with an opening in the vertical direction shown in FIG. 15A, the display surface 11 has end portions.

In the example in FIGS. 15A and 15B, when the user moves the fingertip 6 upward along the display surface 11 by a distance smaller than a width LW of the display surface 11, a displayed image is cyclically shifted while maintaining its identity.

In the example in FIG. 15B, page 2 is displayed while the shifting distance is smaller than the width LW. More specifically, the character string “QRSTUVWXYZ012” positioned at a middle portion of the display surface 11 at time T1 is shifted to a top portion at time T2 and to a bottom portion at time T3.

In the example in FIG. 15B, when the shifting distance becomes greater than or equal to the width LW, page 2 is switched to page 3 at time P4.

### (Tenth Display Example)

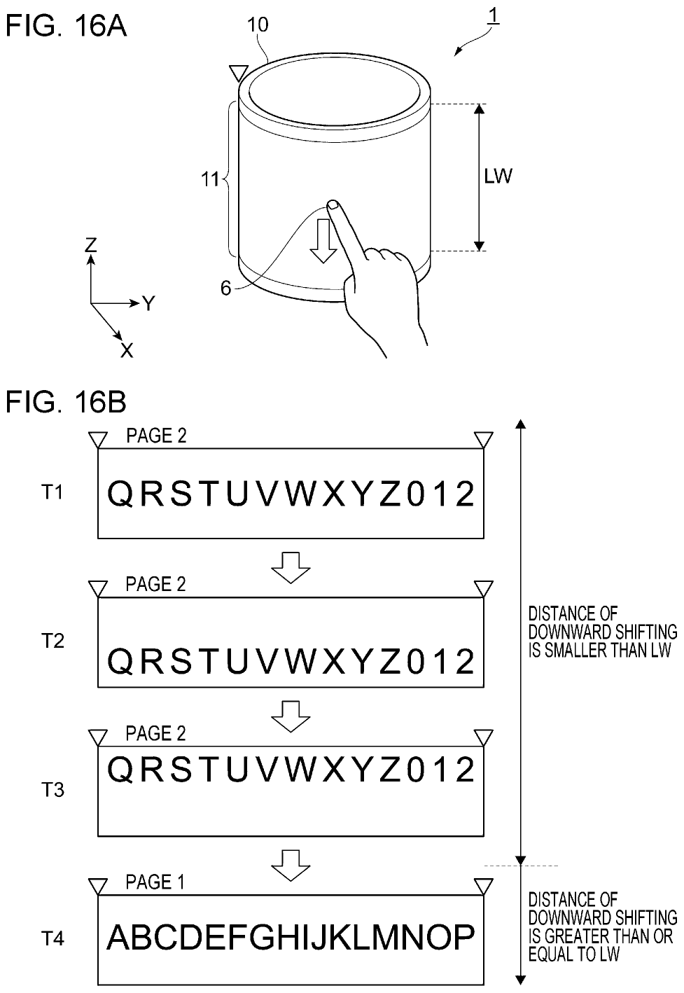

FIGS. 16A and 16B illustrate an example of shifting of the display position of a currently displayed image and switching of the currently displayed image to the previous image in response to a shifting operation in the direction toward the other end portion of the display surface 11. FIG. 16A shows a user operation performed on the information processing apparatus 1. FIG. 16B shows the transition of displayed images in response to a shifting operation.

In the example in FIGS. 16A and 16B, when the user has moved the fingertip 6 downward, the information processing apparatus 1 receives this operation as an instruction to switch to the previous image.

In the example in FIGS. 16A and 16B, when the user moves the fingertip 6 downward along the display surface 11 by a distance smaller than a width LW of the display surface 11, a displayed image is cyclically shifted while maintaining its identity.

In the example in FIG. 16B, page 2 is displayed while the shifting distance is smaller than the width LW. More specifically, the character string ‘QRSTUVWXYZ012” positioned at a middle portion of the display surface 11 at time T1 is shifted to a bottom portion at time T2 and to a top portion at time T3.

In the example in FIG. 16B, when the shifting distance becomes greater than or equal to the width LW, page 2 is switched to page 1 at time P4.

### (Eleventh Display Example)

In the first through tenth display examples, the image displayed on the display surface 11 is cyclically shifted regardless of the direction of a shifting operation received from a user. However, cyclic shifting may be executed when a shifting operation is performed only in a specific direction.

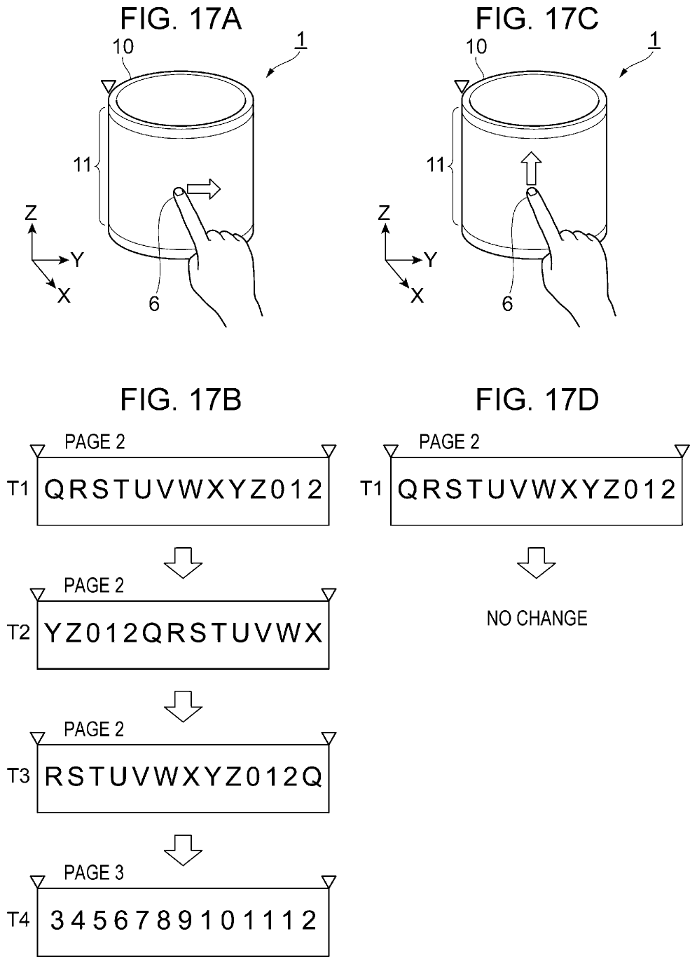

FIGS. 17A and 17B illustrate an example in which a displayed image is cyclically shifted when a user has moved the fingertip 6 in a specific direction. FIGS. 17C and 17D illustrate an example in which a displayed image is not cyclically shifted when a user has moved the fingertip 6 in another direction. FIGS. 17A and 17C show user operations performed on the information processing apparatus 1. FIGS. 17B and 17D each show the transition of displayed images in response to a shifting operation.

In the eleventh display example, when the user has moved the fingertip 6 in the rightward direction (counterclockwise), the image displayed on the display surface 11 is changed in the same manner as in the first display example (see FIG. 7B). In contrast, when the user has moved the fingertip 6 upward, the image on the display surface 11 is not shifted. This is because shifting of an image is restricted to the circumferential direction in the example in FIGS. 17A through 17D.

### (Twelfth Display Example)

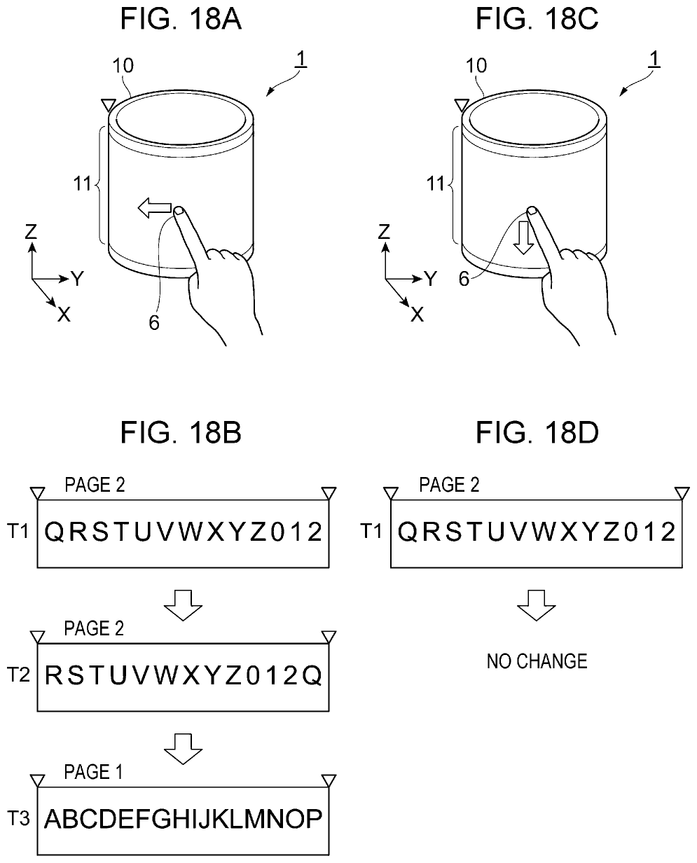

FIGS. 18A and 18B illustrate another example in which a displayed image is cyclically shifted when a user has moved the fingertip 6 in a specific direction. FIGS. 18C and 18D illustrate another example in which a displayed image is not cyclically shifted when a user has moved the fingertip 6 in another direction. FIGS. 18A and 18C show user operations performed on the information processing apparatus 1. FIGS. 18B and 18D each show the transition of displayed images in response to a shifting operation.

In the twelfth display example, when the user has moved the fingertip 6 in the leftward direction (clockwise), the image displayed on the display surface 11 is changed in the same manner as in the second display example (see FIG. 8B). In contrast, when the user has moved the fingertip 6 downward, the image on the display surface 11 is not shifted. This is because shifting of an image is restricted to the circumferential direction in the example in FIGS. 18A through 18E.

### Second Exemplary Embodiment

In the first exemplary embodiment, the body 10 of the information processing apparatus 1 (see FIGS. 1A and 1B) has a cylindrical shape and the display surface 11 is continuous by 360° along the circumferential surface. However, the body 10 is not limited to a cylindrical shape.

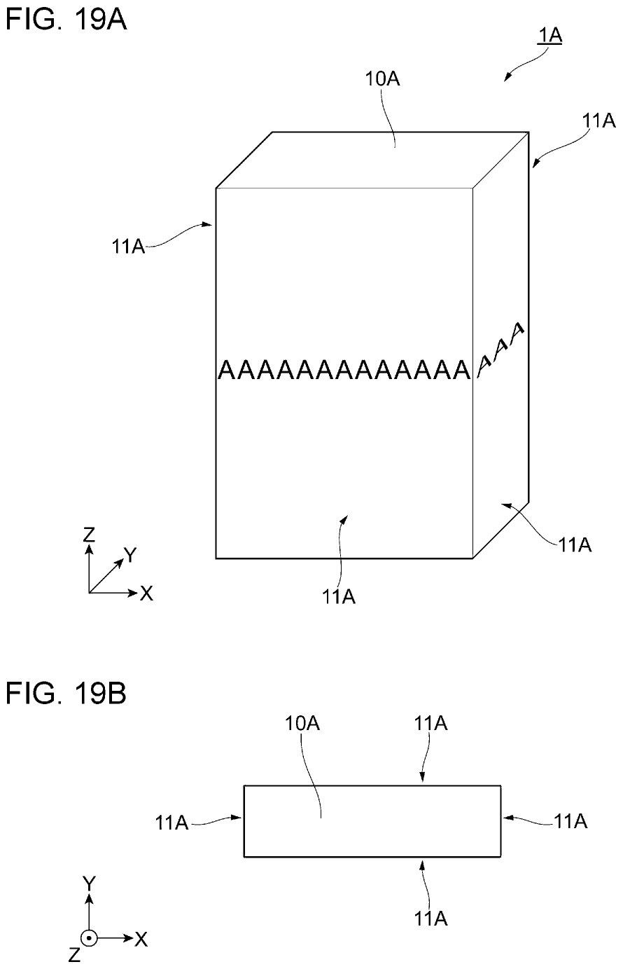

FIGS. 19A and 19B illustrate an information processing apparatus 1A including a body 10A formed in a cuboid shape and four display surfaces 11A disposed continuously on the peripheral surface of the body 10A according to a second exemplary embodiment. FIG. 19A illustrates the outer appearance of the information processing apparatus 1A as viewed from above obliquely. FIG. 19B illustrates the outer appearance of the information processing apparatus 1A as viewed from above.

The display surfaces 11A of the second exemplary embodiment are different from the display surface 11 of the first exemplary embodiment in that four planar display surfaces 11A are continuously disposed. However, the display surfaces 11A may be used similarly to the display surface 11. For example, an image displayed on the display surface 11 may be distributed among the display surfaces 11A.

A user may alternatively use the four display surfaces 11A independently as different display devices. In this case, the image displayed on one display surface 11A is not changed in response to a change in the image on another display surface 11A. Or, the image displayed only on a particular display surface 11A may not be changed in response to a change in the image on another display surface 11A.

### Third Exemplary Embodiment

In the first and second exemplary embodiments, an image can be displayed continuously by 360° in one direction. In a third exemplary embodiment, an image can be displayed continuously by 360° in any direction selected by a user.

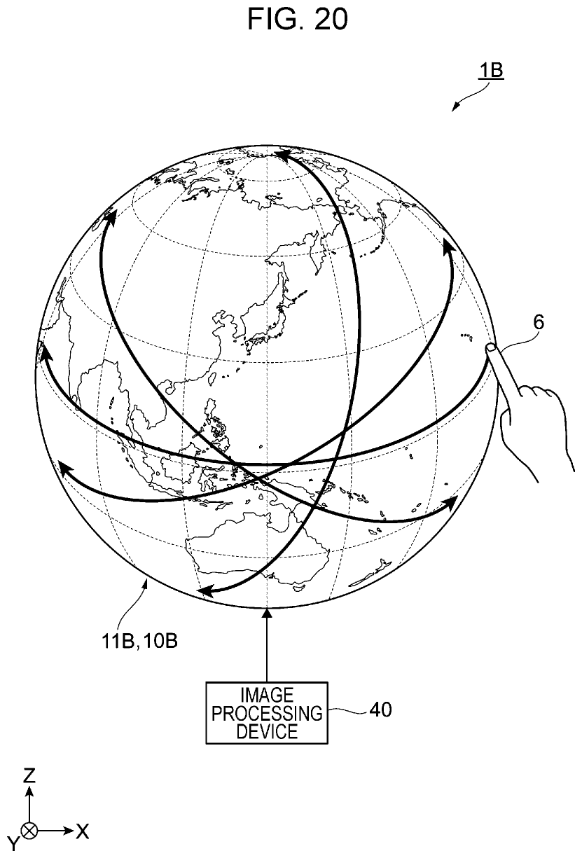

FIG. 20 illustrates an information processing apparatus 1B including a body 10B formed in a spherical shape and a display surface 11B disposed on the surface of the body 10B according to a third exemplary embodiment.

The arrows in FIG. 20 indicate the movement of a fingertip 6 of a user. The display surface 11B is formed in a spherical shape so that the user can move an image displayed on the display surface 11B in any desired direction.

In the third exemplary embodiment, as long as the directions of shifting operations are roughly the same, a difference in the position of the fingertip 6 touched on the display surface 11 is ignored. If differences in shifting directions are strictly distinguished from each other on the spherical display surface 11B, it may be possible that the image will never change.

In the third exemplary embodiment, a certain allowance (width or range) may be given to the shifting direction to manage the shifting distance. The shifting direction may be divided into two directions, that is, the latitude direction and the longitude direction, and the shifting distance may be managed according to each direction.

The spherical display surface 11B is molded from a material, such as glass or plastic resin, so as to have high transparency. The information processing apparatus 1B also includes an image processing device 40.

The image processing device 40 includes a CPU, a ROM, a RAM, and a communication module. The CPU controls the entirety of the information processing apparatus 1B as a result of executing a program (including basic software). The ROM stores programs, such as BIOS and basic software. The RAM is used as a work area for programs. The communication module is used for communicating with an external device.

The image processing device 40 displays an image on the display surface 11B by using a communication module. The image processing device 40 may alternatively be provided within the display surface 11B.

Various techniques may be used to display an image on the spherical display surface 11B, such as projecting an image from the inside of the spherical surface, projecting an image from the outside of the spherical surface, turning ON LEDs disposed on the entirety of the spherical surface to display an image, and rotating a ring-like member having an array of LEDs at high speed within the spherical body and allowing a user to have an afterimage of LED light.

A function of detecting the position of the fingertip 6 of a user on the display surface 11B is also provided on the display surface 11B. Alternatively, the movement of the fingertip 6 may be detected from an image of the display surface 11B captured by a camera.

The information processing apparatus 1B including the display surface 11B and the image processing device 40 separated from each other, as shown in FIG. 20, is an example of an information processing system.

### Fourth Exemplary Embodiment

In the first through third exemplary embodiments, an image can be displayed continuously by 360° at least in one direction. In a fourth exemplary embodiment, a display surface is surrounded by an outer edge (end portion) all around.

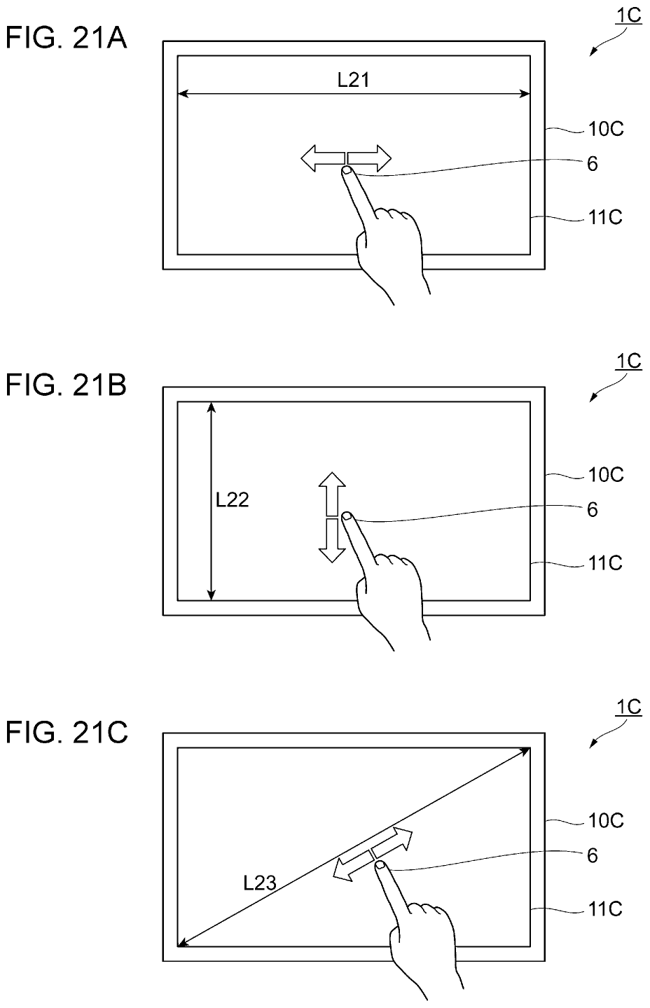

FIGS. 21A through 21C illustrate an information processing apparatus 1C including a body 10C formed in a rectangular cuboid and a rectangular display surface 11C according to a fourth exemplary embodiment. The rectangular display surface 11C is disposed on one of the six surfaces of the body 10C. In FIG. 21A, a user moves the fingertip 6 horizontally. In FIG. 21B, a user moves the fingertip 6 vertically. In FIG. 21C, a user moves the fingertip 6 diagonally to the top right side or to the bottom left side.

Examples of this type of information processing apparatus 1C are a tablet terminal, a smartphone, and a monitor.

The housing (that is, the display surface 11C) of the information processing apparatus 1C may be deformable into one or multiple shapes. In other words, the information processing apparatus 1C may be a flexible display.

For example, if the information processing apparatus 1C is a band-like flexible display, it may be rounded into a cylindrical shape for use.

Although the transition of displayed images in response to a shifting operation is not shown in FIGS. 21A through 21C, a displayed image is cyclically shifted in the horizontal direction, vertical direction, or diagonally to the top right side or to the bottom left side. When the shifting distance in each direction reaches a predetermined distance, the image is switched to another image.

Unlike the curved display surface 11 (see FIG. 1A), the planar display surface 11C is less likely to have blind spots. Nevertheless, the user may still wish to shift a focused portion of an image to an area where the user can easily see it, such as the center of the display surface 11C.

If the shifting distance in the rightward direction reaches a length L21, the current page is switched to the next page. If the shifting distance in the leftward direction reaches the length L21, the current page is switched to the previous page.

If the shifting distance in the upward direction reaches a length L22, the current page is switched to the next page. If the shifting distance in the downward direction reaches the length L22, the current page is switched to the previous page.

If the distance of shifting to the diagonally top right side reaches a length L23, the current page is switched to the next page. If the distance of shifting to the diagonally bottom left side reaches the length L23, the current page is switched to the previous page.

As shown in FIGS. 17A through 17D, cyclic shifting of a displayed image may be restricted to a specific direction.

### Fifth Exemplary Embodiment

In the first through fourth exemplary embodiments, when the shifting distance based on a user instruction reaches a predetermined distance, a displayed image immediately shifts to another image.

In the first through fourth exemplary embodiments, the user can only predict that an image displayed on the display surface 11 will soon be switched based on the display positions of the elements forming the image.

In a fifth exemplary embodiment, a user is informed that image switching will soon occur.

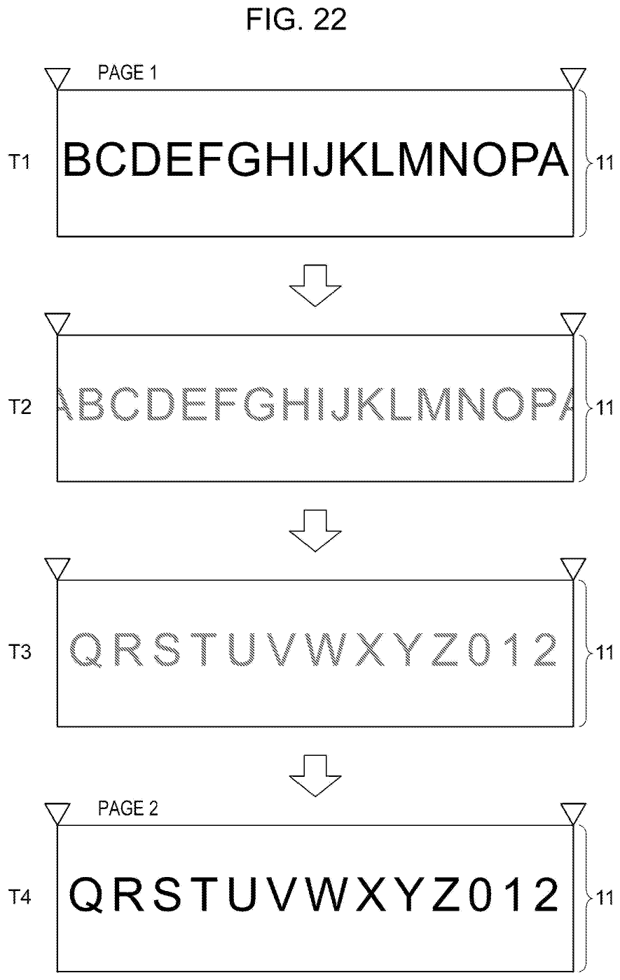

FIG. 22 illustrates an example of a technique for informing a user that image switching will soon occur according to the fifth exemplary embodiment. In this example, in accordance with image switching, a currently displayed image gradually fades out (becomes paler) and another image gradually fades in (becomes thicker).

In the example in FIG. 22, as in the first display example (see FIGS. 7A and 7B), a user moves a fingertip 6 in the rightward direction (counterclockwise) to rotate the position of the displayed image within the display surface 11. In the example in FIG. 22, page 1 is switched to page 2.

At time T1, page 1 will soon be switched to page 2. The character string “BCDEFGHIJKLMNOPA” is displayed in this order in the rightward direction from the reference position on the left side indicated by the inverted triangle. Shifting of this image in the rightward direction (counterclockwise) by one more character will switch page 1 to page 2.

At time T2, page 1 is shifted farther to the right side than that at time T1, and the image has started to fade out with a reduced density (or brightness).

As a result of shifting page 1 farther to the right side, at time T3, page 1 has disappeared and page 2 has started to fade in. Between time T2 and time T3, an image indicating a mixture of page 1 and page 2 may be displayed. At time T4, page 2 is displayed with an increased density (or brightness).

Changing of the density (or the brightness) of the image from time T1 to time T3 makes it possible to let the user know that image switching will soon occur

### Sixth Exemplary Embodiment

In the first through fifth exemplary embodiments, the display surfaces are all physically tangible objects. In a sixth exemplary embodiment, a display surface is formed optically in the air.

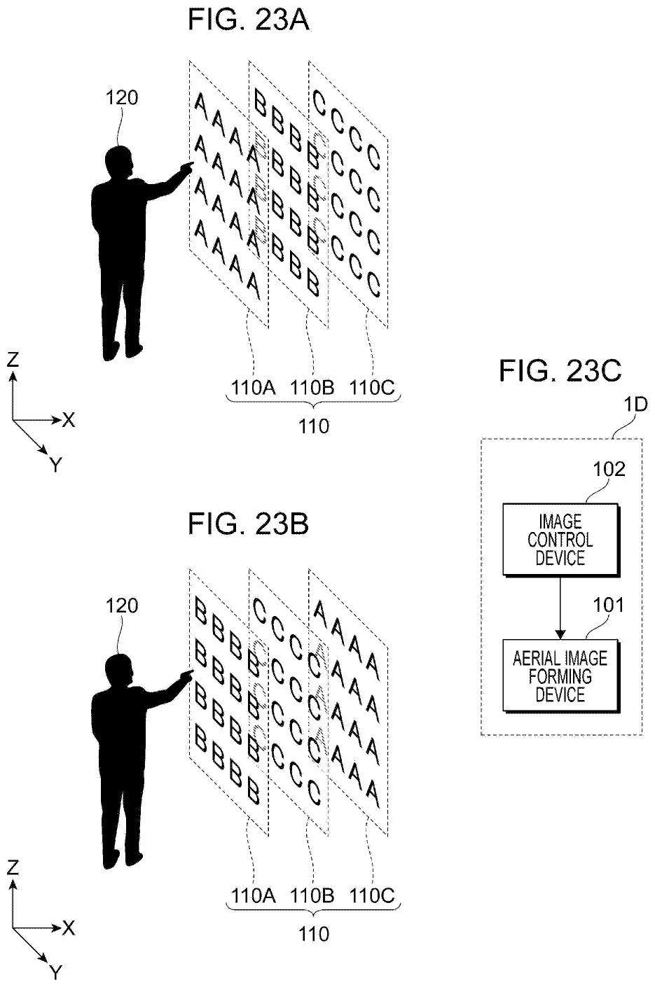

FIGS. 23A through 23C illustrate the schematic configuration of an information processing apparatus 1D which forms an aerial image 110 in the air according to the sixth exemplary embodiment. The information processing apparatus 1D is an example of the information processing system. FIG. 23A illustrates a user 120 providing an instruction to shift the display position of the aerial image 110 by using an aerial image 110A positioned closest to the user 120. FIG. 23B illustrates the aerial image 110 after the display position of the aerial image 110 has been switched.

In the sixth exemplary embodiment, the aerial image 110 is an image formed in the air so as to reproduce the state of light equivalent to light reflected by an object. The aerial image 110 is formed as if it were floating in the air, so that the user 120 can pass through the aerial image 110.

For example, an information screen or an advertising screen may be displayed in the aerial image 110. An operating screen may be displayed in the aerial image 110. On the operating screen, the display content is changed in accordance with an operation of the user 120. These screens are only examples to be displayed in the aerial image 110.

Not only still images, video images may be displayed in the aerial image 110.

In the sixth exemplary embodiment, the entirety of a rectangular shape is used as the aerial image 110. However, the shape which defines the outer edges of the aerial image 110 is not limited to a rectangle. For example, a space in which the image of an object is formed may be used as the space in which the aerial image 110 is formed. Images of an operation button, a person, an animal, a product, and a fruit are examples of the aerial image 110. Although the aerial image 110 has a planar shape in FIGS. 23A and 23B, it may have a three-dimensional shape, such as a curved surface, a sphere, or a cube.

The aerial image 110 may be constituted by a single image. The aerial image 110 may alternatively be constituted by multiple images in one space. In FIGS. 23A and 23B, three planar aerial images 110A, 110B, and 110C are arranged in the depth direction in this order as viewed from the user 120.

In FIGS. 23A and 23B, the aerial image 110A is constituted “AAAA/AAAA/AAAA/AAAA”. The aerial image 110B is constituted by “BBBB/BBBB/BBBB/BBBB”, and the aerial image 110C is constituted by “CCCC/CCCC/CCCC/CCCC”. In all the aerial images 110A, 110B, and 110C, a slash indicates that a new line starts here.

In FIGS. 23A and 23B, the aerial images 110A, 110B, and 110C are disposed such that adjacent aerial images oppose each other with a predetermined distance therebetween. In this case, the first page is displayed in the aerial image 110A, the second page is displayed in the aerial image 110B, and the third page is displayed in the aerial image 110C.

FIGS. 23A and 23B show an example in which the image on the current page is switched to the image on the next page in response to a user instruction. The first image displayed in the aerial image 110A at the front row in FIG. 23A is shifted to the back row in FIG. 23B, and the second page is displayed in the aerial image 110A at the front row in FIG. 23B. That is, the images displayed in the aerial images 110A, 110B, and 110C are moved forward from the back side page by page. Shifting of the first page to the back row is an example of backward shifting.

If image switching in response to a user instruction is conducted in the opposite direction, the image of the third page displayed in the aerial image 110C at the back row is shifted to the aerial image 110A at the front row.

In this case, the first page displayed in the aerial image 110A is shifted to the aerial image 110B at the intermediate row, and the second page displayed in the aerial image 110B is shifted to the aerial image 110C at the back row. That is, the images displayed in the aerial images 110A, 110B, and 110C are moved backward page by page. Shifting of the first page to the intermediate row is also an example of backward shifting.

In this example, multiple pages forming a document are arranged in the multiple aerial images 110A through 110C in the depth direction as viewed from the user 120. However, instead of pages forming a document, drawings or a hierarchical structure, for example, may be arranged in the multiple aerial images 110A through 110C.

The information processing apparatus 1D shown in FIG. 23C includes an aerial image forming device 101, an image control device 102, an imaging camera (not shown), and a microphone (not shown). The aerial image forming device 101 forms the aerial image 110 in the air. The image control device 102 performs control so that the aerial image forming device 101 forms the aerial image 110. The imaging camera captures an image of the user 120 providing an instruction for the aerial image 110. The microphone converts voice of the user 120 into an electric signal.

In FIG. 23C, the single aerial image forming device 101 forms the aerial images 110A, 110B, and 110C. However, different aerial image forming devices may be provided for individually forming the aerial images 110A, 110B, and 110C.

The aerial image forming device 101 is an example of an image forming unit.

The image control device 102 recognizes the content of an instruction provided by the user 120 so as to cause the aerial image forming device 101 to form the aerial images 110A, 110B, and 110C. To recognize the content of the instruction, the image control device 102 uses an image recognition technique of recognizing an image input from the imaging camera and a voice recognition technique of recognizing voice input from the microphone.

The image control device 102 analyzes the motion of a hand or a finger of the user 120, for example, to identify which aerial image the user 120 has selected and the content of an instruction provided by the user 120 for the selected aerial image.

The image control device 102 may alternatively identify the content of the instruction by receiving a signal from a terminal, such as a remote controller.

The image control device 102 is an example of a controller and is also an example of the information processing apparatus.

The imaging camera is disposed at a position at which it can image the motion of a hand or a fingertip of a user. The imaging camera may capture an image of the face of a user so that it can identify the content of an instruction from the facial expression or the gaze of this user.

As the imaging camera, a single imaging camera or plural imaging cameras may be provided. Plural imaging cameras may be installed at different positions and may capture images from different angles. This reduces blind spots, thereby increasing the precision in detecting the movement of the user 120 and identifying the content of an instruction provided by the user 120. Instead of an imaging camera, various sensors may be used. For example, a sensor for detecting the position of a hand or a finger of a user blocking infrared light and for detecting the direction of movement of a hand or a finger of a user may be used. The imaging cameras and sensors are examples of a detector.

The microphone (not shown) is used for inputting voice of the user 120 providing an instruction. The microphone is also an example of the detector.

An explanation will be given through illustration of examples of how the aerial image forming device 101 forms the aerial image 110.

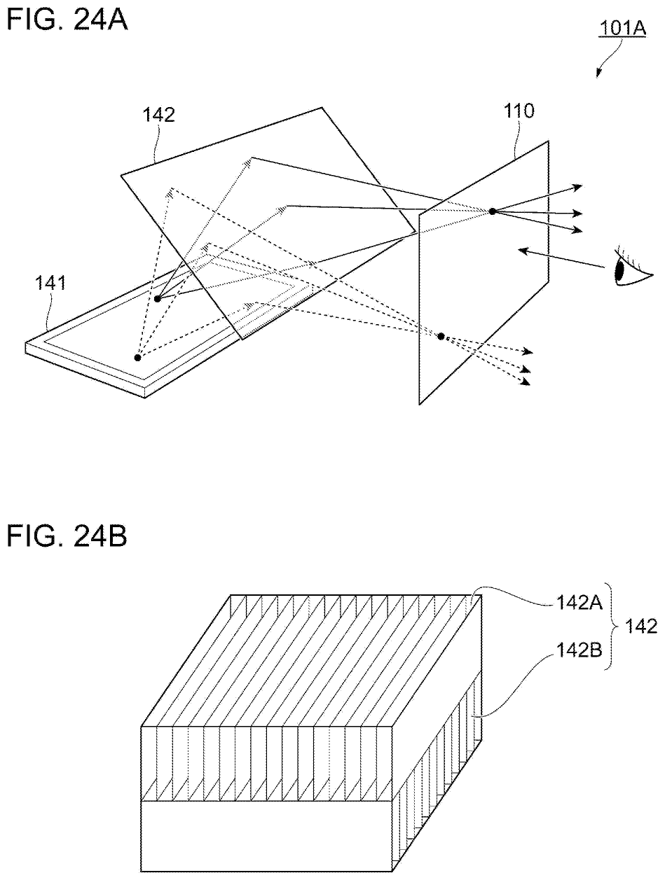

FIGS. 24A and 24B are views for explaining how an aerial image forming device 101A forms an aerial image 110. The aerial image forming device 101A forms the aerial image 110 by causing a dedicated optical plate 142 to transmit light output from a display device 141. FIG. 24A illustrates the positional relationship of the aerial image 110 to the display device 141 and the optical plate 142. FIG. 24B illustrates part of the sectional structure of the optical plate 142. The display device 141 and the optical plate 142 are examples of optical parts.

The optical plate 142 is constituted by two plates vertically overlaid on each other. More specifically, in one plate, glass strips 142A using a wall surface as a mirror are arranged, and in the other plate, glass strips 142B are arranged perpendicularly to the arrangement of the glass strips 142A.

The optical plate 142 reflects light output from the display device 141 twice by using the glass strips 142A and 142B to form an image in the air, thereby reproducing the image displayed on the display device 141 in the air. The distance between the display device 141 and the optical plate 142 is equal to that between the optical plate 142 and the aerial image 110. The dimensions of the image displayed on the display device 141 and those of the aerial image 110 are the same.

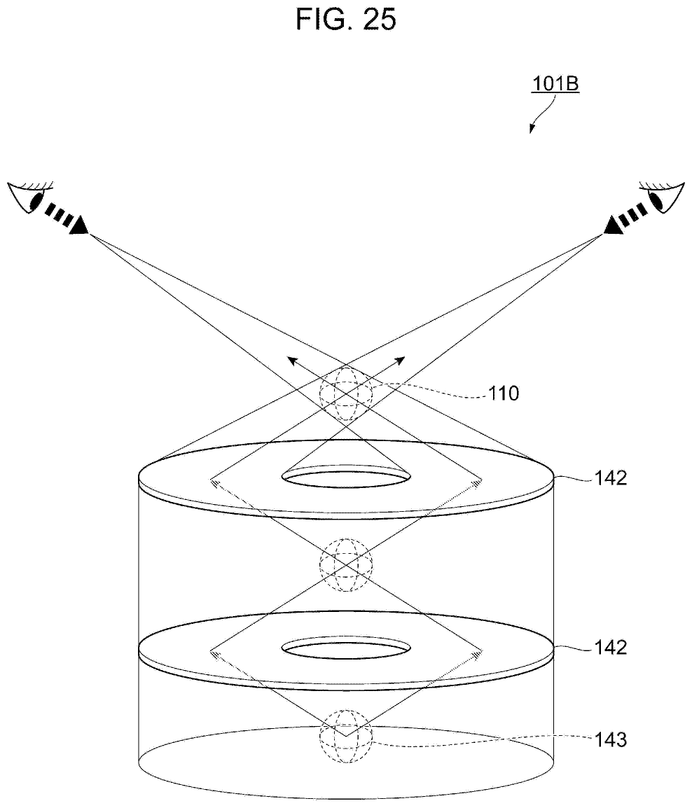

FIG. 25 is a view for explaining how an aerial image forming device 101B forms a three-dimensional image as an aerial image 110. The aerial image forming device 101B causes ring-like optical plates 142 to transmit light twice reflected on the surface of an actual object 143, thereby reproducing a three-dimensional image (aerial image 110) in the air. It is not necessary that the optical plates 142 be disposed in series with each other.

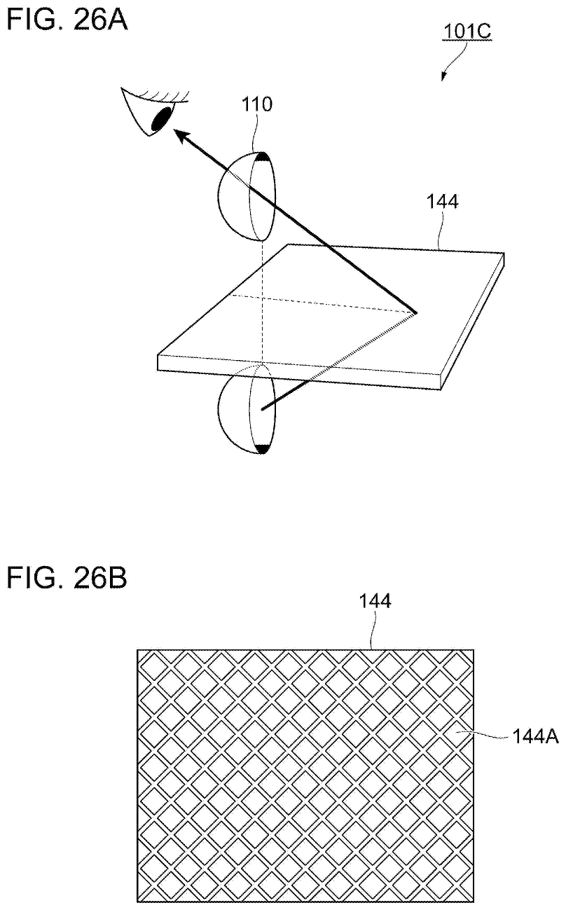

FIGS. 26A and 26B are views for explaining how an aerial image forming device 101C forms an aerial image 110 by using a micromirror array 144. In the micromirror array 144, minute square holes which form a dihedral corner reflector are arranged at equal intervals in the plane. FIG. 26A illustrates the positional relationship of the aerial image 110 to the micromirror array 144. FIG. 26B is a partially enlarged view of the micromirror array 144. One hole 144A has a 100-μm×100-μm square, for example. The micromirror array 144 is an example of optical parts.

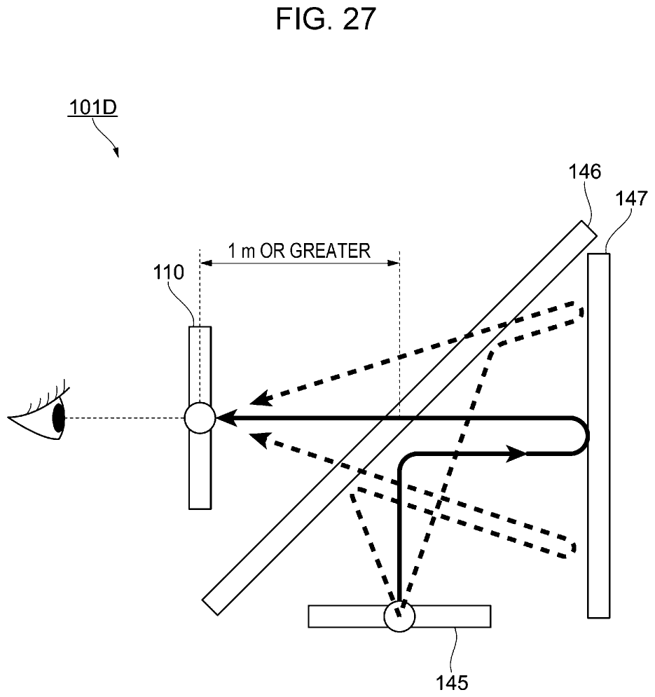

FIG. 27 is a view for explaining how an aerial image forming device 101D forms an aerial image 110 by using a beam splitter 146 and a retroreflective sheet 147. The beam splitter 146 is disposed at 45° with respect to the display surface of a display device 145. The retroreflective sheet 147 is disposed at 90° with respect to the display surface of the display device 145 in the direction of a displayed image reflected by the beam splitter 146. The display device 145, the beam splitter 146, and the retroreflective sheet 147 are examples of optical parts.

In the aerial image forming device 101D, light output from the display device 145 is reflected by the beam splitter toward the retroreflective sheet 147. The light is then reflected by the retroreflective sheet 147 and passes through the beam splitter 146, thereby forming an image in the air at a certain position. The aerial image 110 is thus formed at this position.

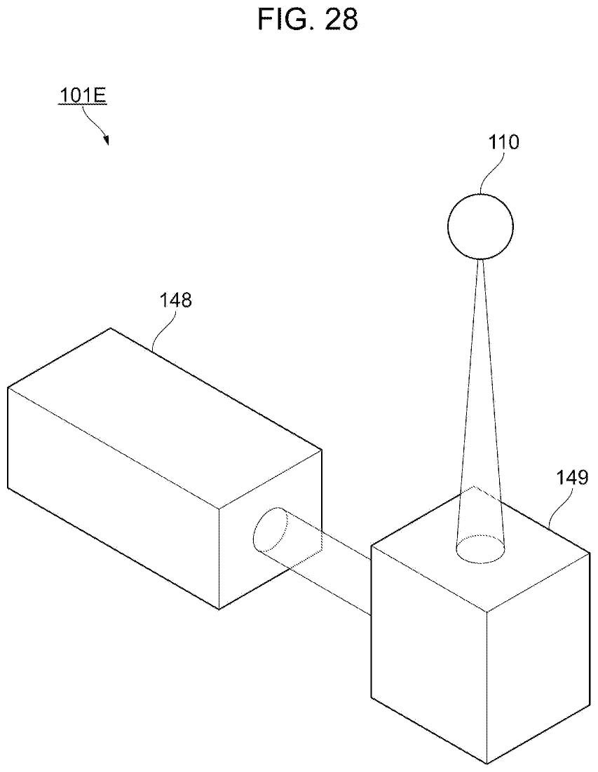

FIG. 28 is a view for explaining how an aerial image forming device 101E forms a set of plasma emitting members as an aerial image 110.

In the aerial image forming device 101E, an infrared pulse laser 148 outputs pulsating laser light, and an XYZ three-dimensional scanner 149 concentrates the pulsating laser light in the air. At this time, a gas in the vicinity of the focal point is momentarily formed into plasma and emits light. The pulse frequency is 100 Hz or lower, for example. The pulse emission time is on the order of nanoseconds, for example. The infrared pulse laser 148 and the XYZ three-dimensional scanner 149 are examples of optical parts.

### Seventh Exemplary Embodiment

A description will he given of a technology for assisting in printing an image displayed on the display surface 11 which is continuous by 360° at least in one direction.

According to the recent progress of display technologies, displaying of a 360°-continuous image by using a cylindrical display device or a spherical display device, for example, has been put to practical use. A camera for imaging a 360°-continuous image is also available. On the other hand, however, a technology for printing a 360°-continuous image on a sheet has not yet been put to practical use.

In a seventh exemplary embodiment, an image is displayed on a display device including a display surface which is continuous in a ring-like shape at least in one direction, as in the first exemplary embodiment. In the seventh exemplary embodiment, a technique for setting an edge portion for printing such an image will he discussed.

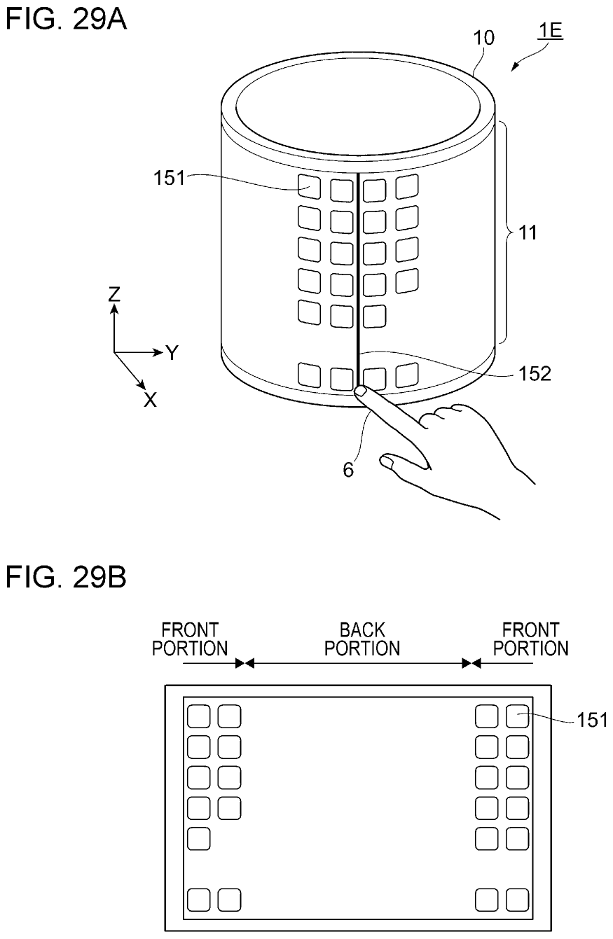

FIGS. 29A and 29B illustrate a technique for setting a print area on a 360°-continuous display surface according to the seventh exemplary embodiment. FIG. 29A illustrates an example of setting a print area on the cylindrical display surface 11. FIG. 29B illustrates a print result.

An information processing apparatus 1E shown in FIG. 29A is the same as the information processing apparatus 1 of the first exemplary embodiment (see FIGS. 1A and 1B).

In the seventh exemplary embodiment, as well as in the first exemplary embodiment, a user moves the fingertip 6 along the cylindrical display surface 11 to set a position.

In the seventh exemplary embodiment, however, the user moves the fingertip 6 to set an edge portion for printing the image displayed on the display surface 11. In FIG. 29A, the user moves the fingertip u vertically to set an edge portion 152.

In this case, the user may not be able to move the fingertip 6 straight and the top edge and the bottom edge may not be at the same position in the circumferential direction. In the information processing apparatus 1E of the seventh exemplary embodiment, a function of correcting the position of the edge portion 152 is provided so that the edge portion 152 can be perpendicular to the display surface 11.

In FIG. 29A, the edge portion 152 is set at a position where four columns of icons 151 are divided into halves. In the example in FIG. 29A, the print direction is set in advance so that printing is performed counterclockwise from the edge portion 152. As a result of the user simply setting the edge portion 152, the print result shown in FIG. 29E is obtained.

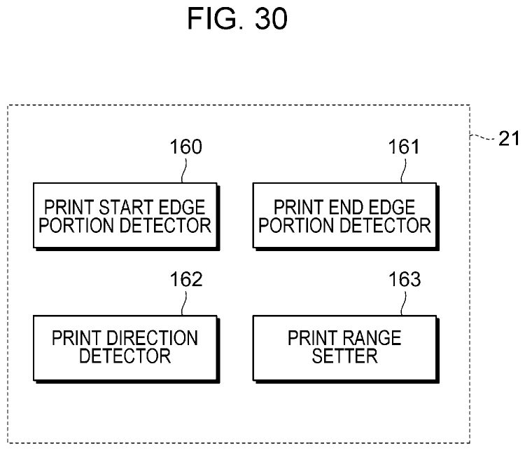

FIG. 30 illustrates examples of functions implemented as a result of the CPU 21 (see FIG. 2) executing a program. In the seventh exemplary embodiment, a function of receiving the setting of an edge portion for printing and a function of setting a print range are required.

To achieve these functions, the CPU 21 serves as a print start edge portion detector 160, a print end edge portion detector 161, a print direction detector 162, and a print range setter 163. The print start edge portion detector 160 detects the position of a print start edge portion. The print end edge portion detector 161 detects the position of a print end edge portion. The print direction detector 162 detects a direction in which printing will start from the detected print start edge portion. The print range setter 163 sets a print range based on the detected edge portions and direction.

If setting of one edge portion is detected, the print start edge portion detector 160 and the print end edge portion detector 161 set this edge portion as the print start edge portion and the print end edge portion. If setting of two edge portions is detected, the print start edge portion detector 160 sets the edge portion which has been set earlier as the print start edge portion, while the print end edge portion detector 161 sets the edge portion which has been set later as the print end edge portion.

The print direction detector 162 is a function to be executed when the print direction (clockwise or counterclockwise) has not been determined in advance. The print direction detector 162 detects whether the user has moved the fingertip 6 clockwise or counterclockwise.

If setting of one edge portion is detected, the print range setter 163 sets a print range starting from the detected edge portion in the predetermined direction or in the detected direction. If setting of two edge portions is detected, the print range setter 163 sets, as a print range, a range from the edge portion detected earlier to that detected later in the predetermined direction or in the detected direction. If the entirety of the outer edge forming a print area is set, the print range setter 163 sets the area defined by this outer edge as a print area.

One of or a combination of the print start edge portion detector 160, the print end edge portion detector 161, the print direction detector 162, and the print range setter 163 function as a receiver concerning a corresponding print function.

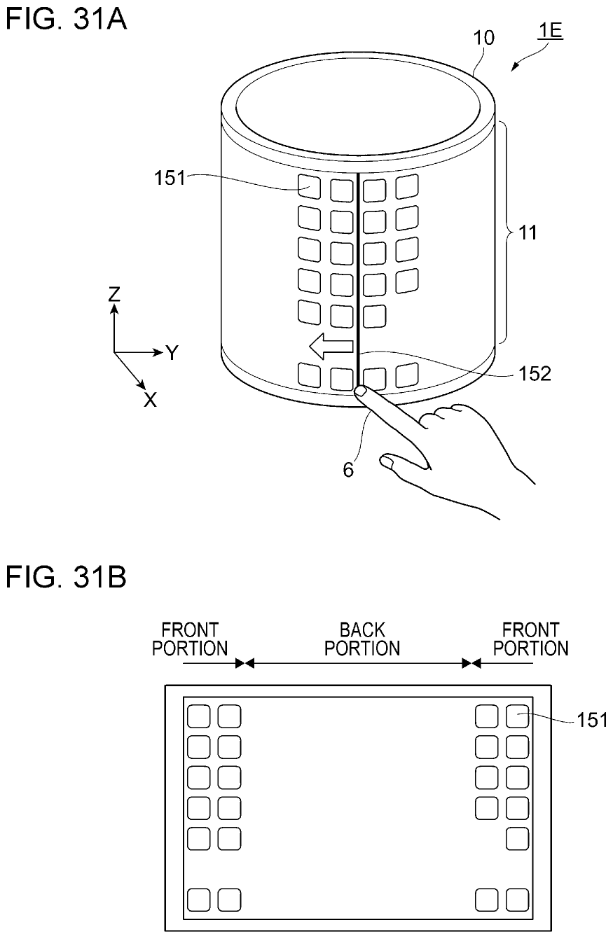

Examples of the execution of printing will be discussed below with reference to FIGS. 31A through 35B.

FIGS. 31A and 31B illustrate an example of the execution of printing when one edge portion 152 is set and the print direction is leftward (clockwise). FIG. 31A shows a user operation, and FIG. 31B shows a print result.

In the example in FIGS. 31A and 31B, information about the image is read from the edge portion 152 in the clockwise direction and is printed on a sheet.

If the user moves the fingertip 6 rightward (counterclockwise), the same print result as that shown in FIG. 29B is obtained.

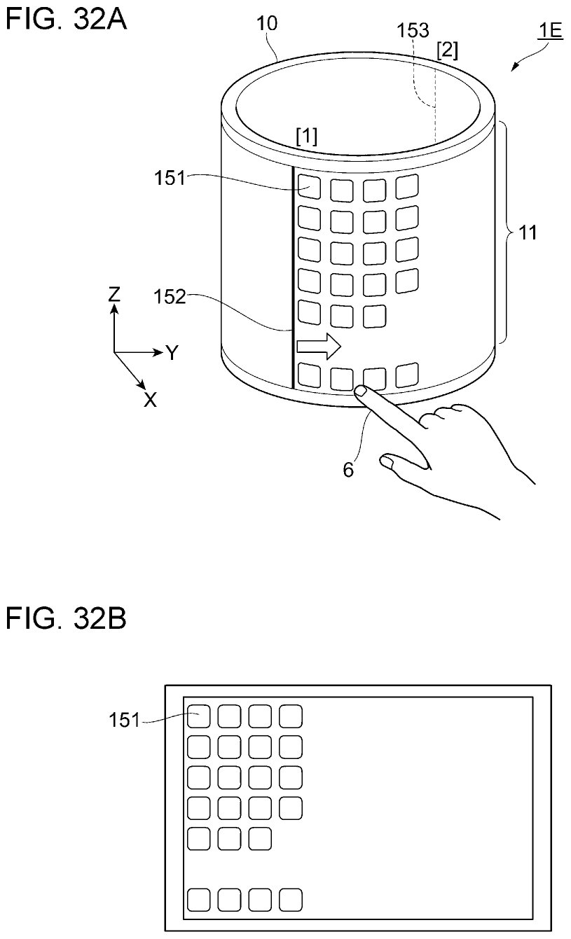

FIGS. 32A and 32B illustrate an example of the execution of printing when two edge portions 152 and 153 are set and the print direction is rightward (counterclockwise). FIG. 32A shows a user operation, and FIG. 32E shows a print result.

The print direction indicated by the arrow in FIG. 32A may be set before the setting of the end portions 152 and 153, or between the settings of the end portions 152 and 153, or after the setting of the end portions 152 and 153.

With the operation shown in FIG. 32A, only a certain portion of the image displayed around 360° can be printed.

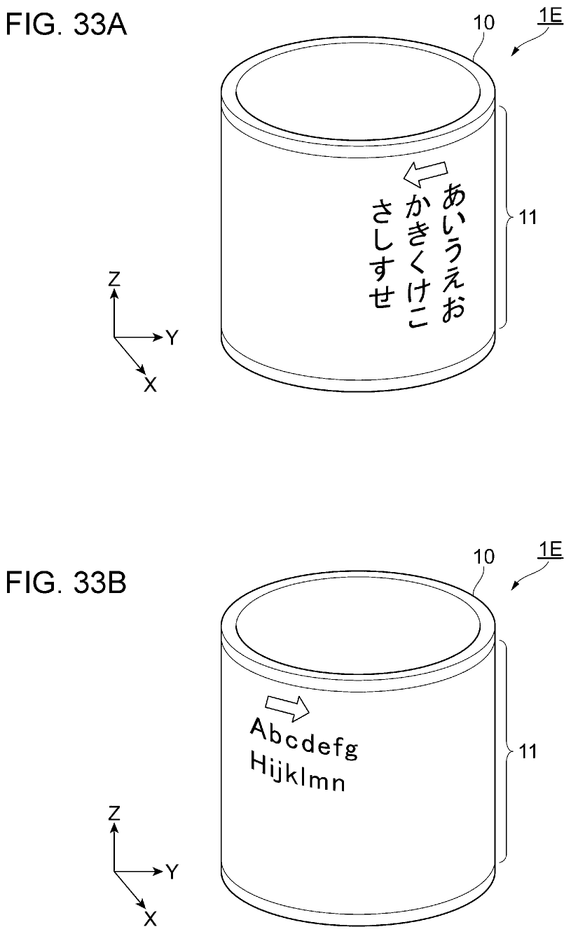

FIGS. 33A and 33B illustrate an example in which the print direction is automatically determined according to the content of a displayed image. FIG. 33A illustrates the print direction for vertically written characters. FIG. 33B illustrates the print direction for horizontally written characters.

In the case of an image showing vertical character strings, such as Kanji (Chinese characters) or Hiragana (Japanese characters), the clockwise direction is set as the print direction. In the case of an image showing horizontal character strings, such as roman characters or numeric characters, the counterclockwise direction is set as the print direction.

In the case of the 360°-continuous display surface 11, if plural areas forming the display surface 11 are distinguishable from each other from the physical shape of the display surface 11, a print range may be set by selecting areas for printing.

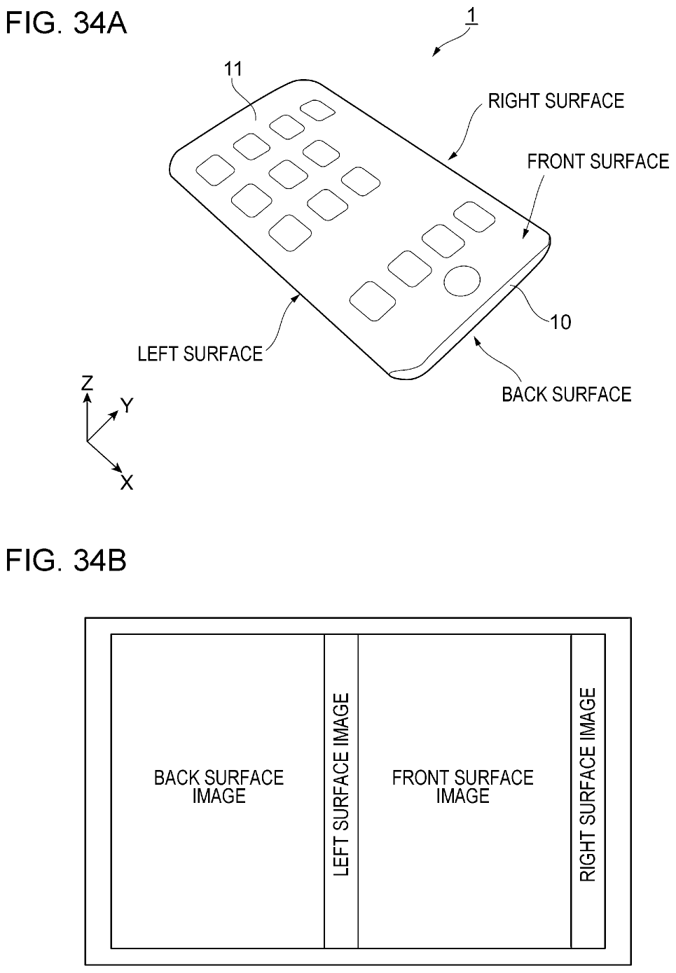

FIGS. 34A and 34B illustrate an example of the execution of printing when display areas of the display surface 11 are distinguishable from each other from the physical shape of the display surface 11. FIG. 34A shows examples of display areas, each of which is managed as the unit of printing. FIG. 34B shows a print result obtained when all the areas have been selected for printing.

The body 10 of the information processing apparatus shown in FIG. 34A has a substantially flat shape. The display surface 11 is constituted by four areas, that is, a front surface, a back surface, a right surface, and a left surface, as units of printing. In the example in FIGS. 34A and 34B, all the four areas are selected for printing, and images in the four areas are thus printed at corresponding positions of a sheet, as shown in FIG. 34B.

The user can select an area to be printed by touching a specific part of the area with a finger. However, for a terminal held by a hand for use, such as a smartphone or a tablet, it is difficult to find whether the user is merely touching a certain portion on the display surface 11 to hold the terminal or the user has selected this portion to be printed.

Accordingly, if, among the four display surfaces, a predetermined portion (around the bottom edge, for example) is touched, it may be determined that this portion has been set for printing.

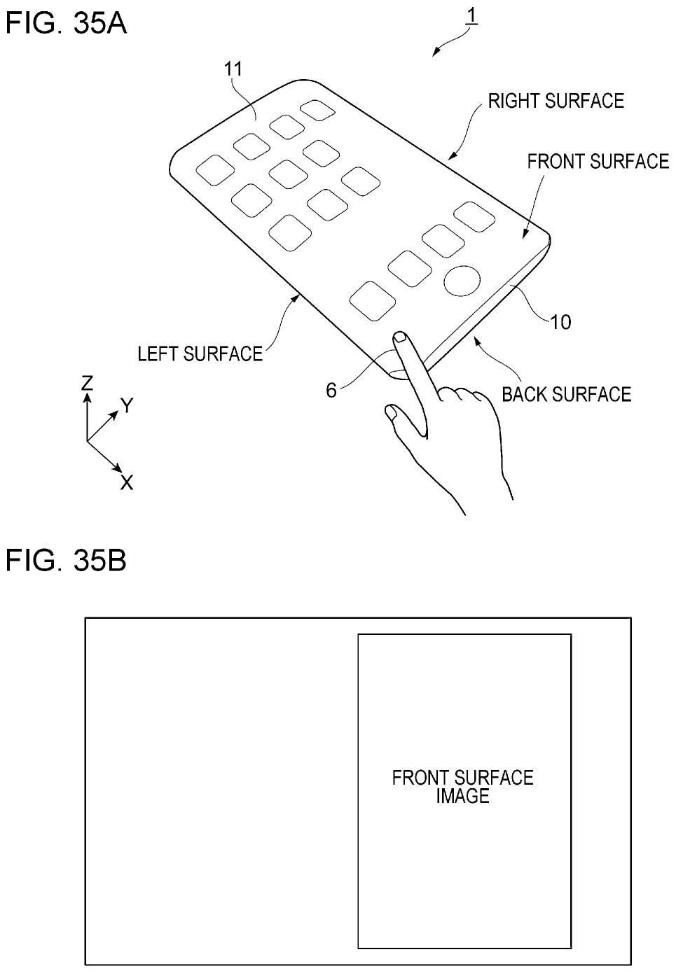

FIGS. 35A and 35B illustrate another example of the execution of printing when display areas of the display surface 11 are distinguishable from each other from the physical shape of the display surface 11. FIG. 35A shows examples of display areas, each of which is managed as the unit of printing. FIG. 35B shows a print result obtained when one area has been selected for printing.

in the example in FIGS. 35A and 35B, among the four areas (front surface, back surface, right surface, and left surface) managed as the units of printing on the display surface 11, the front surface is selected for printing. As a result, only the image on the front surface is printed, as shown in FIG. 35B.

As described above, in the seventh exemplary embodiment, the information processing apparatus 1 including the following receiver has been discussed. When an image is displayed all around the display surface 11 which is continuous by 360° at least in one direction, this receiver receives the setting of a position of an edge portion of an area to be printed.

The receiver has a function of receiving the setting of a print direction, that is, whether the image displayed on the display surface 11 will be printed clockwise or counterclockwise starting from the position of the edge portion. If the image displayed on the display surface 11 contains character strings, the receiver determines a print direction according to the written direction of the characters by using a certain function.

With these functions, the information processing apparatus 1 of the seventh exemplary embodiment is able to output a print result reflecting a layout desirable for a user even in a case in which an image is displayed all around the display surface 11 continuous by 360° at least in one direction.

### Other Exemplary Embodiments

The present disclosure has been discussed through illustration of the above-described exemplary embodiments. Various modifications and improvements may be made to the above-described exemplary embodiments.

For example, in the first, second, and fourth exemplary embodiments, the display surface and the CPU executing the functions are provided in the single information processing apparatus. However, the information processing apparatus may be implemented as an information processing system in which the display surface and the CPU are separately provided.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a receiver that receives a user instruction to shift the entirety of an image, a display position of the image not being fixed; and
a switching unit that causes a currently displayed image to continue to be displayed while a distance by which the currently displayed image is shifted in a direction indicated in the user instruction does not exceed a threshold and that causes the entirety of the currently displayed image to switch to another image when the distance is greater than or equal to the threshold.

2. The information processing apparatus according to claim 1, wherein the receiver receives a user instruction concerning cyclic shifting of an image regardless of the direction of the cyclic shifting.

3. The information processing apparatus according to claim 1, wherein the receiver receives a user instruction concerning cyclic shifting of an image if the direction of the cyclic shifting is a predetermined direction.

4. The information processing apparatus according to claim 1, wherein the content of an image displayed after the currently displayed image has been switched differs according to the direction indicated in the user instruction.

5. The information processing apparatus according to claim 1, wherein, in response to a predetermined specific operation, the switching unit switches the currently displayed image to another image even if the distance does not exceed the threshold.

6. The information processing apparatus according to claim 5, wherein the predetermined specific operation is an operation for selecting an image to he displayed.

7. The information processing apparatus according to claim 1, wherein, for each direction in which an image is shifted, a distance from one end portion to the other end portion of a display surface is determined as the threshold.

8. The information processing apparatus according to claim 1, wherein, if a display surface is formed substantially in a ring-like shape, a distance around the display surface is determined as the threshold.

9. The information processing apparatus according to claim 1, wherein the switching unit switches the currently displayed image such that the currently displayed image gradually becomes paler and another image to be switched from the currently displayed image gradually becomes darker.

10. The information processing apparatus according to claim 1, wherein, if a plurality of display surfaces formed in air are arranged in one direction such that adjacent display surfaces of the plurality of display surfaces oppose each other, an image displayed on the display surface positioned at the frontmost row is shifted to another one of the plurality of display surfaces positioned at a farther backward row so that the entirety of the image displayed on the display surface positioned at the frontmost row is switched to another image.

11. An information processing system comprising:
a receiver that receives a user instruction to shift the entirety of an image, a display position of the image not being fixed;
a switching unit that causes a currently displayed image to continue to be displayed while a distance by which the currently displayed image is shifted in a direction indicated in the user instruction does not exceed a threshold and that causes the entirety of the currently displayed image to switch to another image when the distance is greater than or equal to the threshold; and
a display that displays an image on a display surface.

12. The information processing system according to claim 11, wherein the display surface has a curved shape.

13. The information processing system according to claim 12, wherein the display surface is deformable.

14. The information processing system according to claim 11, wherein the display is worn by a user for use.

15. The information processing system according to claim 11, wherein the display surface is displayed in such a manner that the display surface is floating in the air.

16. A non-transitory computer readable medium storing a program causing a computer to execute a process, the process comprising:
receiving a user instruction to shift the entirety of an image, a display position of the image not being fixed; and
causing a currently displayed image to continue to be displayed while a distance by which the currently displayed image is shifted in a direction indicated in the user instruction does not exceed a threshold and causing the entirety of the currently displayed image to switch to another image when the distance is greater than or equal to the threshold.
